(19) United States
(12) Patent Application Publication
(10) Pub. No.: US 2024/0158235 A1
(43) Pub. Date: May 16, 2024

(54) METHODS, DEVICES AND COMPOSITIONS FOR MODULAR PRODUCTION OF CARBON NANOMATERIALS FROM ACETYLENE USING MICROWAVE CATALYSIS

(71) Applicant: West Virginia University Board of Governors on Behalf of West Virginia University, Morgantown, WV (US)

(72) Inventors: Jianli HU, Morgantown, WV (US); Sonit BALYAN, Morgantown, WV (US); Changle JIANG, Morgantown, WV (US)

(21) Appl. No.: 18/240,325

(22) Filed: Aug. 30, 2023

Related U.S. Application Data
(60) Provisional application No. 63/402,275, filed on Aug. 30, 2022.

(51) Int. Cl. C01B 32/15; C01B 3/26

(52) U.S. Cl. CPC C01B 32/15; C01B 3/26; C01B 2202/34; C01B 2203/0277; C01B 2203/1058; C01B 2203/1082; C01B 2203/1088; C01B 2203/1235; C01P 2002/82; C01P 2002/88; C01P 2004/04

(57) ABSTRACT

In one aspect, the disclosure relates to compositions, processes, and devices for conversion of acetylene to hydrogen and carbon nanomaterials. In a further aspect, the disclosed methods comprise microwave irradiation of a feed stream comprising acetylene in the presence of a catalyst. Also disclosed are compositions produced by the disclosed methods. This abstract is intended as a scanning tool for purposes of searching in the particular art and is not intended to be limiting of the present disclosure.

### CROSS-REFERENCE TO RELATED APPLICATIONS

This Application claims the benefit of U.S. Provisional Application No. 63/402,275, filed on Aug. 30, 2022, which is incorporated herein by reference in its entirety.

### STATEMENT REGARDING FEDERALLY SPONSORED RESEARCH

This disclosure was made with U.S. Government support under contract #DE-FE-0031866, awarded by the U.S. Department of Energy. The U.S. government has certain rights in the disclosure.

### BACKGROUND

Natural gas conversion to hydrogen and solid carbon can drastically reduce the carbon footprint. In particular, hydrogen is one of the most promising and environmentally benign energy sources, since it can be converted into transportation fuel, electricity, and other energy forms with little pollution and high efficiency. However, the two objectives of reduced carbon emissions and enhanced use of hydrogen as a fuel are in direct conflict since the most commercially viable method for hydrogen production is from natural gas via steam methane reforming (SMR), which produces large amounts of carbon dioxide through the following reaction:

CH₄+2H₂O→4H₂+CO₂.

An alternative process to produce hydrogen from methane is plasma pyrolysis, such as microwave plasma pyrolysis, of methane to hydrogen and solid carbon has been intensively developed recently (Refs. 1-3). Advantages for this process are that it neither requires a catalyst nor production of any carbon dioxide which require capture and storage facilities. In addition, the temperature of the reaction is way beyond the traditionally thermal pyrolysis, thus, leading to an extremely high conversion of methane. However, there are two significant drawbacks associated this technology. First there are the by-products generated such as acetylene, ethylene, and benzene, as well as and solid carbon that consists of mainly polycyclic aromatic hydrocarbon, which are produced in addition to the desired hydrogen (Ref. 4). Although the solid carbon product can be easily isolated from the stream by phase-based separation, but the gas-phase by-products such as acetylene, ethylene, and benzene, the separation and utilization of the desired hydrogen product remains a significant technical and economic challenge. Second, the plasma pyrolysis process is associated formation of soot, which is even more problematic disadvantage since it can result in equipment fouling due to accumulative fouling as by-products, such as acetylene, are further decomposed.

Light hydrocarbon by-products, such as methane (Refs. 5-11), ethylene (Refs. 12-13), acetylene (Refs. 14-17), and aromatic gases like benzene (Ref. 18) and toluene (Ref. 19), can be thermally converted to hydrogen and crystalline carbon over a transitional metal catalyst at 500-1000° C. under atmospheric pressure. However, the structural formation of carbon is heavily influenced by the type of carbon source, catalyst composition, and reaction temperature. Although, as mentioned above, there are other types of light hydrocarbons and aromatics by-products produced during plasma pyrolysis of methane, the primary by-product is acetylene and technical solutions to efficiently converting this by-product for further conversion to hydrogen and solid carbon are critical to the success of plasma pyrolysis for production of hydrogen from methane.

Thermal decomposition of unsaturated hydrocarbon by-products (primarily acetylene) is a potential solution to the production of acetylene during plasma pyrolysis of methane as process to further decompose acetylene and other light hydrocarbons. One study has shown that nickel can decompose acetylene to amorphous carbon at 600° C. and crystalline carbon at 1000° C. (Ref. 20). Fe supported by silica was adopted as catalyst to decompose acetylene to carbon nanotubes and carbon nanofibers at 700° C. (Ref. 15). Multiwalled CNT was generated with catalytic decomposition of acetylene over CoₓMg₍₁₋ₓ₎O solid solution at 600° C. (Ref. 21). Transition metals such as Fe, Co, and Ni have been reported as the catalysts for the thermal decomposition of acetylene (Refs. 22-25), as well as other active transition metals such as Cu, Mo, Cr, and the like have been reported as the catalysts for the thermal decomposition of acetylene (Refs. 25-29).

Despite advances in research directed to improving the plasma pyrolysis of methane process, particularly with regard to how to address the production of by-products such as acetylene, there remain a scarcity of methods that are efficient, economical, and practical. These needs and other needs are satisfied by the present disclosure.

### SUMMARY

In accordance with the purpose(s) of the disclosure, as embodied and broadly described herein, the disclosure, in one aspect, relates to compositions, processes, and devices for conversion of acetylene to hydrogen and carbon nanomaterials. In a further aspect, the disclosed methods comprise microwave irradiation of a feed stream comprising acetylene in the presence of a catalyst. Also disclosed are compositions produced by the disclosed methods.

Disclosed are methods for producing hydrogen and carbon nanomaterials from acetylene, the method comprising: (a) applying microwave radiation to the acetylene in the presence of a catalyst comprising metal atoms, wherein the microwave radiation causes the acetylene to decompose into hydrogen and at least one solid carbon product; separating the hydrogen and the at least one solid carbon product.

Also disclosed are methods for producing hydrogen and carbon nanomaterials from acetylene, the method comprising: (a) applying microwave radiation to the acetylene in the presence of a catalyst comprising metal atoms, wherein the microwave radiation causes the acetylene to decompose into hydrogen and at least one solid carbon product; (c) contacting the catalyst and the at least one solid carbon product with an acid composition, wherein the acid composition causes the metal atoms to separate from the at least one solid carbon product; (d) removing the metal atoms from the acid composition; and (e) removing the at least one solid carbon product from the acid composition.

Also disclosed are compostions comprising hydrogen and carbon nanomaterials produced by the disclosed methods.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A-1F shows schematic representations and flow diagrams of a disclosed methods and processes. FIG. 1A shows a disclosed processes integrating the disclosed methods for conversion of acetylene with plasma pyrolysis of methane wherein gasesous products, including hydrogen and by-product gases such as acetylene, are directed to a system and device for carrying out the disclosed methods and processes. FIG. 1B shows a flow diagram for a plasma pyrolysis of methane, such as conventional methods of plasma pyrolysis, which as shown in FIG. 1A, can be directly integrated with the disclosed methods and processes. FIG. 1C shows a flow diagram for a disclosed method of converting acetylene to hydrogen and carbon nanomaterials. FIG. 1D shows a disclosed two stage acetylene pyrolysis reactor comprising a first stage of microwave irradiation of input gases comprising acetylene, and a second stage comprising a catalyst bed comprising a disclosed catalyst, wherein the catalyst bed is irradiated with microwave energy. FIG. 1E shows a schematic representation of a disclosed process. FIG. 1F shows an exemplary process as disclosed herein.

FIGS. 2A-2B show representative data relating to catalytic performance in a disclosed process. FIG. 2A shows acetylene conversion as a function of time for a disclosed process carried out using a disclosed 10Ni-1Pd-CNT catalyst with heating of the catalyst using microwave irradiation to a catalyst temperature of 500° C. FIG. 2B shows product concentration (mol %) as a function of time for the process described in FIG. 2A.

FIGS. 3A-3B show representative data relating to catalytic performance in a disclosed process. FIG. 3A shows acetylene conversion as a function of time for a disclosed process carried out using a disclosed 10Ni—Al₂O₃ catalyst with heating of the catalyst using microwave irradiation to a catalyst temperature of 400° C. FIG. 3B shows product concentration (mol %) as a function of time for the process described in FIG. 3A. FIGS. 3C-3E catalytic performance in a disclosed process for reactions carried out over 10Ni—Al₂O₃ at 400° C. (thermal heating): FIG. 3C shows additional data for acetylene conversion; FIG. 3D shows additional data for H2 concentration; and FIG. 3E shows additional data for CH4 concentration.

FIGS. 4A-4B show representative TEM images showing morphology, particle size, diameter, and growth of CNT formed over spent 10Ni—Al₂O₃ and 10Ni-1Pd-Al₂O₃ catalyst in a disclosed process under the conditions described in FIGS. 3A-3B. FIG. 4A shows a representative TEM image of CNT formed over spent 10Ni—Al₂O₃ with the scalar bar shown in the lower left of the image. FIG. 4B shows a representative TEM image of CNT formed over spent 10Ni-1 Pd—Al₂O₃ with the scalar bar shown in the lower left of the image.

FIG. 5 shows representative Raman spectra obtained of spent 10Ni—Al₂O₃ and 10 Ni-1Pd-Al₂O₃ catalyst with heating of the catalyst using microwave irradiation to heat to a catalyst temperature of 400° C.

FIG. 6 show representative data relating to catalytic performance in a disclosed process. The shown include acetylene conversion as a function of time for a disclosed process carried out using a disclosed 10Ni-CNT and 10Ni-1Pd-CNT catalysts with heating of the catalyst using microwave irradiation to heat to a catalyst temperature of 400° C. (see solid symbols—which have the data for the 10Ni-1 Pd-CNT superimposed over and obscuring the data for the 10Ni-CNT catalyst data). Data are also show for representative product concentration (mol %) as a function of time for the same reaction conditions.

FIGS. 7A-7B show representative TEM images showing morphology, particle size, diameter, and growth of CNT formed over spent 10Ni-CNT and 10Ni-1Pd-CNT catalyst in a disclosed process with heating of the catalyst using microwave irradiation to a catalyst temperature of 400° C. FIG. 7A shows a representative TEM image of CNT formed over spent 10Ni-CNT with the scalar bar shown in the lower left of the image. FIG. 7B shows a representative TEM image of CNT formed overspent 10Ni-1Pd-CNT with the scalar bar shown in the lower left of the image.

FIGS. 8A-8B show representative TGA data for disclosed catalysts used in a disclosed process. FIG. 8A shows TGA analysis for pristine CNT, 10Ni-CNT (unheated/unused), and 10Ni-CNT after heating in a disclosed process at 400° C. with microwave irradiation. FIG. 8B shows TGA analysis for pristine CNT, 10Ni-1Pd-CNT (unheated/unused), and 10Ni-1Pd-CNT after heating in a disclosed process at 400° C. with microwave irradiation.

FIGS. 9A-9B show representative Raman spectra obtained from disclosed catalysts used in a disclosed process. FIG. 9A shows a Raman spectrum for pristine CNT, 10Ni-CNT (unheated/unused), and 10Ni-CNT after heating in a disclosed process at 400° C. with microwave irradiation. FIG. 9B shows a Raman spectrum for pristine CNT, 10Ni-1Pd-CNT (unheated/unused), and 10Ni-1Pd-CNT after heating in a disclosed process at 400° C. with microwave irradiation.

FIGS. 10A-10B show representative data relating to catalytic performance in a disclosed process. FIG. 10A shows acetylene conversion as a function of time for a disclosed process carried out using a disclosed 10Ni-CNT catalyst with heating of the catalyst using microwave irradiation to a catalyst temperature of 400° C. FIG. 10B shows product concentration (mol %) as a function of time for the process described in FIG. 10A. FIG. 10C shows acetylene conversion as a function of time for a disclosed process carried out using a disclosed 10Ni-CNT catalyst compared to 10Ni-1Pd-CNT catalyst with heating of the catalyst using microwave irradiation to a catalyst temperature of 400° C. FIG. 10D shows product concentration (mol %) as a function of time for the process described in FIG. 10C.

FIGS. 11A-11B show representative TEM images showing morphology, particle size, diameter, and growth of CNT formed over spent 10Ni-CNT catalyst in a disclosed process with heating of the catalyst using microwave irradiation to a catalyst temperature of 400° C. versus thermal heating to a catalyst temperature of 400° C. FIG. 11A shows a representative TEM image of CNT formed over spent 10Ni-CNT following heating with microwave irradiation, with the scalar bar shown in the lower left of the image. FIG. 11B shows a representative TEM image of CNT formed over spent 10Ni-CNT following thermal heating, with the scalar bar shown in the lower left of the image. FIGS. 11C-11E catalytic performance in a disclosed process for reactions carried out over 10Ni-CNT at 400° C. (microwave heating): FIG. 11C shows additional data for acetylene conversion; FIG. 11D shows additional data for H2 concentration; and FIG. 11E shows additional data for CH4 concentration. FIGS. 11F-11H catalytic performance in a disclosed process for reactions carried out over 10Ni-CNT at 400° C. (thermal heating): FIG. 11F shows additional data for acetylene conversion; FIG. 11G shows additional data for H2 concentration; and FIG. 11H shows additional data for CH4 concentration. FIGS. 111-11K catalytic performance in a disclosed process for reactions carried out over 10Ni-CNT at 350° C. (microwave heating): FIG. 11I shows additional data for acetylene conversion; FIG. 11J shows additional data for H2 concentration; and FIG. 11K shows additional data for CH4 concentration. FIGS. 11L-11N catalytic performance in a disclosed process for reactions carried out over 10Ni-CNT at 350° C. (thermal heating): FIG. 11L shows additional data for acetylene conversion; FIG. 11M shows additional data for H2 concentration; and FIG. 11N shows additional data for CH4 concentration.

FIGS. 12A-12B show representative TGA data and Raman spectra obtained from disclosed catalysts used in a disclosed process. FIG. 12A shows TGA analysis for pristine CNT, unheated 10Ni-CNT, 10Ni-CNT heated to 400° C. with microwave irradiation (denoted as “10Ni-CNT-400” in the figure), and 10Ni-CNT thermally heated to 400° C. (denoted as “10Ni-CNT-400 Thermal” in the figure). FIG. 12B shows a Raman spectrum for pristine CNT, unheated 10Ni-CNT, 10Ni-CNT heated to 400° C. with microwave irradiation (denoted as “10Ni-CNT-400” in the figure), and 10Ni-CNT thermally heated to 400° C. (denoted as “10Ni-CNT-400 Thermal” in the figure). FIGS. 12C and 12D each show XRD analysis of pure CNT and the indicated catalysts before and after reaction. FIGS. 12E-12H each show temperature programmed reductions with hydrogen (TPR-H2) were carried out for the indicated catalysts, i.e., as indicated, TPR of fresh catalyst (10Ni-CNT; 10Ni-Al₂O₃; 10Ni-1Pd-Al₂O₃; 10Ni-1 Pd-CNT), and spent catalysts (all others as indicated).

FIGS. 13A-13B show representative data relating to catalytic performance in a disclosed process. FIG. 13A shows acetylene conversion as a function of time for a disclosed process carried out using a disclosed 10Ni-CNT catalyst with heating of the catalyst using microwave irradiation to a catalyst temperature of 400° C. or 350° C. as indicated in the figure. FIG. 13B shows product concentration (mol %) as a function of time for the process described in FIG. 13A. FIG. 13C shows acetylene conversion as a function of time for a disclosed process carried out using a disclosed 10Ni-CNT catalyst with heating of the catalyst using microwave irradiation to a catalyst temperature of 400° C. or 350° C. as indicated in the figure. FIG. 13D shows product concentration (mol %) as a function of time for the process described in FIG. 13C.

FIGS. 14A-14B show representative TEM images showing morphology, particle size, diameter, and growth of CNT formed over spent 10Ni-CNT catalyst in a disclosed process with heating of the catalyst using microwave irradiation to a catalyst temperature of 400° C. versus to a catalyst temperature of 350° C. FIG. 14A shows a representative TEM image of CNT formed over spent 10Ni-CNT following heating with microwave irradiation to a catalyst temperature of 400° C., with the scalar bar shown in the lower left of the image. FIG. 14B shows a representative TEM image of CNT formed over spent 10Ni-CNT following heating with microwave irradiation to a catalyst temperature of 350° C., with the scalar bar shown in the lower left of the image.

FIGS. 15A-15B show representative TGA data and Raman spectra obtained from disclosed catalysts used in a disclosed process. FIG. 15A shows TGA analysis for pristine CNT, unheated 10Ni-CNT, 10Ni-CNT heated to 400° C. with microwave irradiation (denoted as “10Ni-CNT-400” in the figure), and 10Ni-CNT heated to 350° C. with microwave irradiation (denoted as “10Ni-CNT-350” in the figure). FIG. 15B shows a Raman spectrum for pristine CNT, unheated 10Ni-CNT, 10Ni-CNT heated to 400° C. with microwave irradiation (denoted as “10Ni-CNT-400” in the figure), and 10Ni-CNT heated to 350° C. with microwave irradiation (denoted as “10Ni-CNT-350” in the figure).

FIGS. 16A-16B show representative data relating to catalytic performance in a disclosed process. FIG. 16A shows acetylene conversion as a function of time for a disclosed process carried out using a disclosed 10Ni-1Pd-CNT catalyst with heating of the catalyst using microwave irradiation to a catalyst temperature of 400° C. or 350° C. as indicated in the figure. FIG. 16B shows product concentration (mol %) as a function of time for the process described in FIG. 16A. FIG. 16C shows acetylene conversion as a function of time for a disclosed process carried out using a disclosed 10Ni-1Pd-CNT catalyst with heating of the catalyst using microwave irradiation to a catalyst temperature of 400° C. or 350° C. as indicated in the figure. FIG. 16D shows product concentration (mol %) as a function of time for the process described in FIG. 16C. FIGS. 16E-16G catalytic performance in a disclosed process for reactions carried out over 10Ni-1Pd-CNT at 350° C. (microwave heating): FIG. 16E shows additional data for acetylene conversion; FIG. 16F shows additional data for H2 concentration; and FIG. 16G shows additional data for CH4 concentration. FIGS. 16H-16J catalytic performance in a disclosed process for reactions carried out over 10Ni-1Pd-CNT at 350° C. (microwave heating; catalyst reduced at 550° C.): FIG. 16H shows additional data for acetylene conversion; FIG. 16I shows additional data for H2 concentration; and FIG. 16J shows additional data for CH4 concentration. FIGS. 16K-16M catalytic performance in a disclosed process for reactions carried out over 10Ni-1Pd-CNT at 400° C. (microwave heating): FIG. 16K shows additional data for acetylene conversion; FIG. 16L shows additional data for H2 concentration; and FIG. 16M shows additional data for CH4 concentration.

FIGS. 16H-16J catalytic performance in a disclosed process for reactions carried out over 10Ni-1 Pd-CNT at 350° C. (thermal heating): FIG. 16H shows additional data for acetylene conversion; FIG. 16I shows additional data for H2 concentration; and FIG. 16J shows additional data for CH4 concentration.

FIGS. 17A-17B show representative data relating to catalytic performance in a disclosed process. FIG. 17A shows acetylene conversion as a function of time for a disclosed process carried out using a disclosed 10Ni-1Pd-CNT catalyst with heating of the catalyst using microwave irradiation to a catalyst temperature of 400° C. or 550° C. as indicated in the figure. FIG. 17B shows product concentration (mol %) as a function of time for the process described in FIG. 17A. FIG. 17C shows acetylene conversion as a function of time for a disclosed process carried out using a disclosed 10Ni-1Pd-CNT catalyst with heating of the catalyst using microwave irradiation to a catalyst temperature of 400° C. or 550° C. as indicated in the figure. FIG. 17D shows product concentration (mol %) as a function of time for the process described in FIG. 17C.

FIGS. 18A-18B show representative TEM images showing morphology, particle size, diameter, and growth of CNT formed over spent 10Ni-CNT catalyst in a disclosed process with heating of the catalyst using microwave irradiation to a catalyst temperature of 400° C. versus to a catalyst temperature of 550° C. FIG. 18A shows a representative TEM image of CNT formed over spent 10Ni-CNT following heating with microwave irradiation to a catalyst temperature of 400° C., with the scalar bar shown in the lower left of the image. FIG. 18B shows a representative TEM image of CNT formed over spent 10Ni-CNT following heating with microwave irradiation to a catalyst temperature of 550° C., with the scalar bar shown in the lower left of the image.

FIGS. 19A-19B show representative TGA data and Raman spectra obtained from disclosed catalysts used in a disclosed process. FIG. 19A shows TGA analysis for pristine CNT, unheated 10Ni-1Pd-CNT, 10Ni-1Pd-CNT heated to 400° C. with microwave irradiation (denoted as “10Ni-1Pd-CNT-400” in the figure), and 10Ni-1Pd-CNT heated to 550° C. with microwave irradiation (denoted as “10Ni-1Pd-CNT-550” in the figure). FIG. 19B shows a Raman spectrum for pristine CNT, unheated 10Ni-1 Pd-CNT, 10Ni-1 Pd-CNT heated to 400° C. with microwave irradiation (denoted as “10Ni-1 Pd-CNT-400” in the figure), and 10Ni-1 Pd-CNT heated to 550° C. with microwave irradiation (denoted as “10Ni-1Pd-CNT-550” in the figure).

FIGS. 20A-20B show representative TGA data obtained from disclosed catalysts used in a disclosed process. FIG. 20A shows TGA analysis for pristine CNT compared to 10Ni—Al₂O₃ heated to 400° C. with microwave irradiation (denoted as “10Ni—Al₂O₃-400” in the figure). FIG. 20B shows TGA analysis for pristine CNT compared to 10Ni-1Pd-Al₂O₃ heated to 400° C. with microwave irradiation (denoted as “10Ni-1Pd-Al₂O₃-400” in the figure).

FIG. 21 shows a representative TEM image of the CNT support used in some aspects of the disclosed catalysts.

FIGS. 22A-22B show representative data relating to catalytic performance in a disclosed process. FIG. 22A shows acetylene conversion as a function of time for a disclosed process carried out using a disclosed 10Ni—Al₂O₃ catalyst with heating of the catalyst using microwave irradiation to a catalyst temperature of 400° C. FIG. 22B shows product concentration (mol %) as a function of time for the process described in FIG. 22A. FIG. 22C shows acetylene conversion as a function of time for a disclosed process carried out using a disclosed 10Ni-CNT catalyst with heating of the catalyst using either microwave irradiation or thermal heating to a catalyst temperature of 400° C. FIG. 22D shows product concentration (mol %) as a function of time for the process described in FIG. 22C. FIG. 22E shows acetylene conversion as a function of time for a disclosed process carried out using a disclosed 10Ni—Al₂O₃ catalyst with heating of the catalyst using microwave irradiation to a catalyst temperature of 400° C. FIG. 22F shows product concentration (mol %) as a function of time for the process described in FIG. 22E.

FIGS. 23A-23B show representative TEM images showing morphology, particle size, diameter, and growth of CNT formed over spent 10Ni—Al₂O₃ spent catalyst under in a disclosed process with heating of the catalyst using microwave irradiation to a catalyst temperature of 400° C. versus thermal heating to 400° C. FIG. 23A shows a representative TEM image of CNT formed over spent 10Ni—Al₂O₃ following heating with microwave irradiation to a catalyst temperature of 400° C., with the scalar bar shown in the lower left of the image. FIG. 23B shows a representative TEM image of CNT formed over spent 10Ni—Al₂O₃ following thermal heating to a catalyst temperature of 400° C., with the scalar bar shown in the lower left of the image.

FIGS. 24A-24B show representative TGA data obtained from disclosed catalysts used in a disclosed process versus thermal heating. FIG. 24A shows TGA analysis for pristine CNT compared to 10Ni—Al₂O₃ heated to 400° C. with microwave irradiation (denoted as “10Ni—Al₂O₃-400” in the figure) and 10Ni—Al₂O₃ heated to 400° C. with thermal heating (denoted as “10Ni—Al₂O₃₋₄₀₀ thermal” in the figure). FIG. 24B shows Raman spectra for pristine CNT compared to 10Ni—Al₂O₃ heated to 400° C. with microwave irradiation (denoted as “10Ni—Al₂O₃₋₄₀₀” in the figure) and 10Ni—Al₂O₃ heated to 400° C. with thermal heating (denoted as “10Ni—Al₂O₃-400 thermal” in the figure).

FIGS. 25A-25B show representative TEM images showing morphology, particle size, diameter, and growth of CNT formed over spent 10Ni-1Pd-CNT spent catalyst under in a disclosed process with heating of the catalyst using microwave irradiation to a catalyst temperature of 400° C. versus microwave irradiation to a catalyst temperature of 350° C. FIG. 25A shows a representative TEM image of CNT formed over spent 10Ni-1Pd-CNT following heating with microwave irradiation to a catalyst temperature of 400° C., with the scalar bar shown in the lower left of the image. FIG. 25B shows a representative TEM image of CNT formed over spent 10Ni-1Pd-CNT following heating with microwave irradiation to a catalyst temperature of 350° C., with the scalar bar shown in the lower left of the image.

FIGS. 26-26B show representative TGA data obtained from disclosed catalysts used in a disclosed process versus thermal heating. FIG. 26A shows TGA analysis for pristine CNT compared to unheated 10Ni-1Pd-CNT, 10Ni-1Pd-CNT heated to 400° C. with microwave irradiation (denoted as “10Ni-1Pd-CNT-400” in the figure) and 10Ni-1Pd-CNT heated to 350° C. with microwave irradiation (denoted as “10Ni-1Pd-CNT-350” in the figure). FIG. 26B shows Raman spectra for pristine CNT compared to unheated 10Ni-1 Pd-CNT, 10Ni-1 Pd-CNT heated to 400° C. with microwave irradiation (denoted as “10Ni-1Pd-CNT-400” in the figure) and 10Ni-1Pd-CNT heated to 350° C. with microwave irradiation (denoted as “10Ni-1Pd-CNT-350” in the figure).

FIGS. 27A-27I show representative carbon nanomaterial size distribution data for spent catalyst. FIG. 27A shows carbon nanomaterial size distribution of spent catalyst, Ni—Al₂O₃ (microwave heating). FIG. 27B shows carbon nanomaterial size distribution of spent catalyst, Ni—Al₂O₃ (thermal heating). FIG. 27C shows carbon nanomaterial size distribution of spent catalyst Ni—Pd—Al₂O₃. FIG. 27D shows carbon nanomaterial size distribution of spent catalyst, Ni-CNT (microwave heating at 400° C.). FIG. 27E shows carbon nanomaterial size distribution of spent catalyst, Ni-CNT (microwave heating at 350° C.). FIG. 27F shows carbon nanomaterial size distribution of spent catalyst, Ni-CNT (thermal heating). FIG. 27G shows carbon nanomaterial size distribution of spent catalyst, Ni—Pd—CNT (microwave heating at 400° C.). FIG. 27H shows carbon nanomaterial size distribution of spent catalyst, Ni—Pd—CNT (microwave heating at 350° C.). FIG. 27I shows carbon nanomaterial size distribution of spent catalyst, Ni—Pd—CNT (microwave heating at 350° C., reduced at 550° C.).

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a gas”, “a catalyst”, or “a metal” includes, but is not limited to, combinations of two or more such gases, catalysts or metals, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a catalyst refers to an amount that is sufficient to achieve the desired improvement in the property modulated by the formulation component, e.g. achieving the desired level of hydrocarbon conversion over time. The specific level in terms of wt % in a composition required as an effective amount will depend upon a variety of factors including the amount and type of metal used as catalyst, amount and type of support (if any), number of reaction cycles, and recycling/recovery strategy for the catalyst.

As used herein, the terms “optional” or “optionally” means that the subsequently described event or circumstance can or cannot occur, and that the description includes instances where said event or circumstance occurs and instances where it does not.

“Carbon nanomaterials” are carbon-based materials having at least one dimension on the nanometer scale in size (i.e., from 1 to 1000 nm). Carbon nanomaterials can include, but are not limited to, nanoparticles, fullerenes, carbon filaments, single- and multi-walled carbon nanotubes (CNTs), carbon nanofibers (CNFs), and various graphene-based materials.

As used herein, “carbon filaments” include materials such as “carbon nanotubes” and “carbon nanofibers.” Carbon filaments are graphite-based and typically have diameters from 0.4 to 500 nm, with lengths in the micrometer-to-millimeter scale range. Carbon nanotubes (CNT) can have single walls or can be multiwalled. CNTs have typically been prepared in the past using laser ablation, arc discharge, and/or chemical vapor deposition methods. In a further aspect, known methods for producing CNTs have drawbacks such as, for example, a requirement for high temperatures (1200-3000° C.) or a requirement to be produced in a vacuum or low pressure process. In an alternative aspect, non-catalytic decomposition of methane at temperatures from about 1000-1100° C. is known to produce amorphous carbon rather than CNTs or other carbon filaments. In one aspect, CNFs may consist of several different forms or layers of carbon. In some aspects, CNFs have properties similar to CNTs but lower tensile strength. In one aspect, CNFs are not hollow, while CNTs are hollow. In one aspect, CNTs and CNFs are used herein as supports for catalysts used in the processes disclosed herein. In another aspect, CNTs and CNFs are also products of the processes disclosed herein. In one aspect, CNTs and/or CNFs have potential applications in sensors including those useful in biomedical applications, electronic devices, lithium-ion batteries, hydrogen storage cells, protection from electrostatic discharge, structural reinforcement in construction and building projects, thin films, increasing the tensile strength of materials, textiles, coatings and films, solar cells, and numerous other related applications.

As used herein, “amorphous carbon” is carbon lacking a crystalline structure. Amorphous carbon is free and usually reactive, although it can be stabilized. In one aspect, the methods and processes disclosed herein can be fine-tuned to favor the production of CNTs and/or CNFs over amorphous carbon. In one aspect, non-catalytic decomposition of methane at high temperatures may produce some amount of amorphous carbon.

As used herein, “tip growth” refers to a mechanism for growth of CNTs where methane decomposes on the top surface of the metal catalyst, carbon diffuses downwards, and CNT precipitates, pushing the catalyst off the substrate. “Base growth,” meanwhile, refers to a mechanism for growth of CNTs where CNT formation does not push the catalyst up and CNT grows out of the metal at the point farthest from the substrate. In one aspect, the CNT formed via the methods disclosed herein grow via a base growth mechanism. In another aspect, the CNT formed via the methods disclosed herein grow via a tip growth mechanism.

“COₓ-free” and “CO₂” free refer to processes and methods that do not produce measurable amounts of carbon dioxide, carbon monoxide, or related compounds as byproducts. In one aspects, the processes and methods disclosed herein are COₓ-free, CO₂-free, or both. In a further aspect, COₓ-free and CO₂-free processes are environmentally-sound as they do not release excess greenhouse gases into the atmosphere.

A “spent” or “deactivated” catalyst is a catalyst that can no longer catalyze a desired reaction. Catalysts may become spent or deactivated by a variety of means including poisoning (strong absorption of species at catalytic sites), fouling (physical deposition of material on the catalyst surface), mechanical stresses such as abrasion or crushing, and the like. A spent or deactivated catalyst can be regenerated but this is often an expensive, multistep process requiring the operation of complex equipment. Spent catalysts that cannot be or will not be regenerated typically contain heavy metals and must be discarded as hazardous waste. In one aspect, provided herein are facile methods for regenerating the catalysts used in the processes disclosed here, thereby avoiding the costly and environmentally hazardous problem of processing spent catalysts.

A “monometallic” catalyst is a catalyst that includes ions or atoms of one metal only. A “bimetallic” catalyst includes ions or atoms of two metals in any proportion relative to one another. In one aspect, the catalysts disclosed herein are monometallic or bimetallic. In another aspect, additional catalysts incorporating combinations of three, four, or more metals.

In some aspects, Raman spectroscopy can be used to evaluate the compositions disclosed herein after 1, 2, 3 4, 5, or more cycles of use. In some aspects, the “ID/IG” ratio can be used as a basis for estimating amount of structured versus unstructured carbon in a sample. In one aspect, the D band is reflective of disordered structure and is located between about 1300 and about 1400 cm⁻¹ and the G band is reflective of content of sp² hybridized carbon (i.e., ordered) and is located between about 1500 and about 1600 cm⁻¹, although these values can vary slightly based on particular aspects of the samples being analyzed. ID/IG ratio is most helpful when comparing similar samples such as, for example, catalyst/CNT compositions after one or more use cycles as disclosed herein. A relatively higher ID/IG ratio (i.e., comparison of relative peak areas) indicates a larger proportion of disordered carbon is present in a sample, while a relatively lower ID/IG ratio indicates a larger proportion of structured or sp² hybridized carbon is present. An unchanged ID/IG between different treatments indicates the proportions of structured and unstructured carbon are essentially unchanged between treatments.

As used herein, the Brunauer-Emmet-Teller method (“BET method”) is typically used to determine surface area of a solid such as a catalyst in a manner that incorporates coverage of multiple layers.

As used herein, “thermogravimetric analysis” or “TGA” is a technique in which sample mass is measured over time as temperature is changed. TGA can be useful in the disclosed applications for determining crystallinity of the carbon materials produced.

As used herein, “h” is an abbreviation that means “hours”.

Unless otherwise specified, temperatures referred to herein are based on atmospheric pressure (i.e. one atmosphere).

### B. INTRODUCTION

In one aspect, the disclosure relates to methods and processes for conversion of acetylene produced during plasma pyrolysis of methane. More specifically, in one aspect, the present disclosure relates to methods and processes that can be efficiently utilized in the production stream of plasma pyrolysis of methane that avoids the need for gas separation of acetylene produced as a by-product. Moreover, the disclosed methods not only obviate the need for separation of acetylene from hydrogen during plasma pyrolysis of methane, but do so in a method and process that produces value added products such as additional hydrogen and useful carbon nanomaterials.

As discussed above, microwave plasma pyrolysis is an emerging process to directly convert methane (CH₄), the major component of natural gas, to hydrogen and carbon, which offers benefits such as fast process dynamics, flexibility, and high product yield. However, the formation of unwanted by-products, like acetylene (C₂H₂), will add additional cost to these processes for gas separation. Conventional plasma pyrolysis of CH₄ produces large amount of acetylene, which even if separated from the desired product, hydrogen, has limited commercial application, which is currently used mainly for welding. The industry is seeking processes and methods that would avoid the costs of gas separation of acetylene, which results in a product that has limited commercial value, and/or to upgrade acetylene to value added products from this significant by-product, i.e., acetylene, of plasma pyrolysis of methane.

Disclosed herein are methods and processes that directly address the need for improved work- and product-flows of plasma pyrolysis of methane, i.e., disclosed processes that provide for transformation of the acetylene by-product to value-added carbon nanotubes (CNT) and pure hydrogen (H₂). In a further aspect, the disclosed methods and processes utilize a Ni-based catalyst with heating using microwave irradiation. In a still further aspect, the disclosed methods and processes provide hydrogen as the dominant gas product, with low concentrations of methane, ethane, and ethylene in the product stream. In a yet further aspect, the disclosed methods and processes can be carried out at relatively low temperatures, at least by comparison to conventional methods of either catalytic conversion or thermal decomposition of hydrogen, which typically utilize temperatures in excess of 500° C. as discussed in the Background.

In a further aspect, the disclosed methods and processes can provide for acetylene decomposition at temperatures of from about 300° C. to about 500° C. using the disclosed catalysts, e.g., Ni-based catalyst having a Al₂O₃ support and/or CNT support. In a further aspect, the Ni-based catalyst is a monometallic catalyst. In a still further aspect, the Ni-based catalyst is a bimetallic catalyst comprising Ni and Pd.

The disclosed methods and processes utilizing the disclosed catalysts with microwave irradiation can be used to create a modular reactor device comprising switch on and off functionality capable of providing an enhanced heating and cooling reaction conditions that mitigates catalytic decomposition. Moreover, a disclosed modular reactor device can be used on site and/or proximal to plasma pyrolysis of methane near sites of methane extraction. The use of microwave irradiation can result in low catalyst bulk temperature when compared to the traditionally thermal heating using an electric furnace. Although, microwave irradiation has been adopted for catalytic decomposition of many hydrocarbons, such as methane (Refs. 11 and 30) and ethane (Ref. 31-32), it was heretofore not been for the catalytic decomposition of acetylene or in this context.

### C. METHODS FOR PRODUCING HYDROGEN AND CARBON NANOMATERIALS FROM ACETYLENE

Disclosed herein are methods for producing hydrogen and carbon nanomaterials from acetylene, the method comprising: (a) applying microwave radiation to acetylene in the presence of a catalyst comprising metal atoms, wherein the microwave radiation causes the acetylene to decompose into hydrogen and at least one solid carbon product. In a further aspect, the acetylene is a reaction product gas mixture from plasma pyrolysis of methane. In a still further aspect, the reaction product gas mixture from plasma pyrolysis of methane is used directly in the disclosed methods without further purification.

In a further aspect, disclosed herein are methods for producing hydrogen and carbon nanomaterials from acetylene, the method comprising: (a) applying microwave radiation to acetylene in the presence of a catalyst comprising metal atoms, wherein the microwave radiation causes the acetylene to decompose into hydrogen and at least one solid carbon product; (b) collecting the hydrogen; (c) contacting the catalyst and the at least one solid carbon product with an acid composition, wherein the acid composition causes the metal atoms to separate from the at least one solid carbon product; (d) removing the metal atoms from the acid composition; and (e) removing the at least one solid carbon product from the acid composition. In a further aspect, the acetylene is a reaction product gas mixture from plasma pyrolysis of methane. In a still further aspect, the reaction product gas mixture from plasma pyrolysis of methane is used directly in the disclosed methods without further purification.

Also disclosed herein are methods for producing hydrogen and carbon nanomaterials from acetylene, the method comprising: (a) applying microwave radiation to the acetylene in the presence of a catalyst comprising metal atoms, wherein the microwave radiation causes the acetylene to decompose into hydrogen and at least one solid carbon product; (b) collecting the hydrogen; (c) contacting the catalyst and the at least one solid carbon product with an acid composition, wherein the acid composition causes the metal atoms to separate from the at least one solid carbon product; (d) removing the metal atoms from the acid composition; and (e) removing the at least one solid carbon product from the acid composition; wherein the catalyst comprises Ni and optionally Pd. In a further aspect, the acetylene is a reaction product gas mixture from plasma pyrolysis of methane. In a still further aspect, the reaction product gas mixture from plasma pyrolysis of methane is used directly in the disclosed methods without further purification.

In another aspect, the solid carbon nanomaterials comprise nanoparticles, fullerenes, carbon filaments, single-walled carbon nanotubes (SWCNT), multi-walled carbon nanotubes (MWCNT), carbon nanofibers (CNF), or a combination thereof. In another aspect, the carbon nanomaterials comprise SWCNT, MWCNT, and/or CNF. In a further aspect, the SWCNT, MWCNT, and/or CNF can have an outer diameter from about 10 to about 500 nm, or from about 15 to about 300 nm, or of about 10, 25, 50, 75, 100, 125, 150, 175, 200, 225, 250, 275, 300, 325, 350, 375, 400, 425, 450, 475, or about 500 nm, or a combination of any of the foregoing values, or a range encompassing any of the foregoing values. In another aspect, the SWCNT, MWCNT, and/or CNF can have a length from about 20 nm to about 50 μm, or from about 20 nm to about 50 μm, or from about 50 nm to about 25 μm, or of about 20, 40, 50, 60, 80, 100, 250, 500, or 750 nm or about 1, 2, 5, 10, 15, 20, 25, 30, 35, 40, 45, or about 50 μm, or a combination of any of the foregoing values, or a range encompassing any of the foregoing values.

In a further aspect, the method further includes step (f): using a portion of the carbon nanomaterials produced in the reaction as a supporting solid carbon product to restart the method beginning at step (a). In another aspect, about 5 to about 90 wt % of the at least one solid carbon product is used to restart the method, or about 10 to about 50 wt % of the at least one solid carbon product, or about 5, 10, 15, 20, 25, 30, 35, 40, 45, 50, 55, 60, 65, 70, 75, 80, 85, or about 90 wt % of the solid carbon product is used, or a combination of any of the foregoing values, or a range encompassing any of the foregoing values.

In a further aspect, the acid composition can include nitric acid. In another aspect, the nitric acid is from about 0.5 to about 12 M, or is about 3 M, or is about 0.5, 1, 1.5, 2, 2.5, 3, 3.5, 4, 4.5, 5, 5.5, 6, 6.5, 7, 7.5, 8, 8,5, 9, 9.5, 10, 10.5, 11, 11.5, or about 12 M, or a combination of any of the foregoing values, or a range encompassing any of the foregoing values. In a still further aspect, step (c) is carried out for about 3-5 h at from about 110 to about 130° C., or for about 4 h at about 120° C. In still another aspect, the solid carbon product and the catalyst can be contacted with a second acid composition. In another aspect, the second acid composition can be nitric acid. In a yet further aspect, the second acid composition can be concentrated nitric acid and the contact with this second acid composition is for about 12 hours at from about 130 to about 150° C., or at about 140° C.

In any of these aspects, the disclosed method can be repeated at least 1, 2, 3, or 4 times without a degradation in performance.

In any of these aspects, the disclosed method can be conducted in an inert atmosphere. In a further aspect, the inert atmosphere can include nitrogen, argon, or a combination thereof. In one aspect, the reaction gas hourly space velocity can be from about 5000 to about 50,000 h⁻¹⁻, or can be about 5000, 6000, 7000, 8000, 9000, 10,000, 20,000, 30,000, 40,000 or about 50,000 h-W, or can be about 10,000 h⁻¹. In another aspect, the method can be carried out for from about 5 to about 800 min for each cycle, or at about 5, 10, 15, 20, 25, 50, 75, 100, 125, 150, 175, 200, 225, 250, 275, 300, 350, 400, 450, 500, 550, 600, 650, 700, 750, or about 800 min, or a combination of any of the foregoing values, or a range encompassing any of the foregoing values.

In any of these aspects, the disclosed method can be conducted at a pressure of from about 0.1 atm to about 10 atm. In a further aspect, the disclosed method can be conducted at a pressure of from about 0.1 atm to about 2 atm. In a still further aspect, the disclosed method can be conducted at a pressure of essentially ambient pressure, e.g., at about 1 atm ±20%. In a yet further aspect, the disclosed method can be conducted at a pressure of about 1 atm ±10%. In an even further aspect, the disclosed method can be conducted at a pressure of from of about 0.1 atm to about 1.9 atm, of from about 0.2 atm to about 1.8 atm, of from about 0.3 atm to about 1.7 atm, of from about 0.4 atm to about 1.6 atm, of from about 0.5 atm to about 1.5 atm, of from about 0.6 atm to about 1.4 atm, of about 0.7 atm to about 1.3 atm, of from about 0.8 atm to about 1.2 atm, of from about 0.9 atm to about 1.1 atm, of from about 0.95 atm to about 1.05 atm, or a sub-range of any of the foregoing; or a discrete set of values within any of the foregoing.

Also disclosed herein are compositions produced by the disclosed methods disclosed herein, e.g., compositions produced by the disclosed methods comprising hydrogen and/or a carbon nanomaterial.

In one aspect, the methods disclosed herein are particularly useful for the direct conversion of gaseous by-products of plasma pyrolysis of methane, e.g., acetylene produced as a by-product of plasma pyrolysis of methane. In a further aspect, the method can be performed using modular components that are at deployable field locations that involve extraction of methane and on-site plasma pyrolysis of the extracted methane. In a still further aspect, the method can be performed using modular components that are deployable field locations having on-site plasma pyrolysis of methane. In a further aspect, the modular components can operate at varying feed rates and compositions as required by local conditions.

In one aspect, the modular units disclosed herein can be deployed at flared gas sites, and resulting CNTs and CNFs can be transported by truck, railroad, or another means to a site for further processing. In a further aspect, the hydrogen gas produced by the process disclosed herein can be converted to electricity via fuel cell, or can be reacted with nitrogen or carbon dioxide to generate transportable liquid ammonia or liquid fuel.

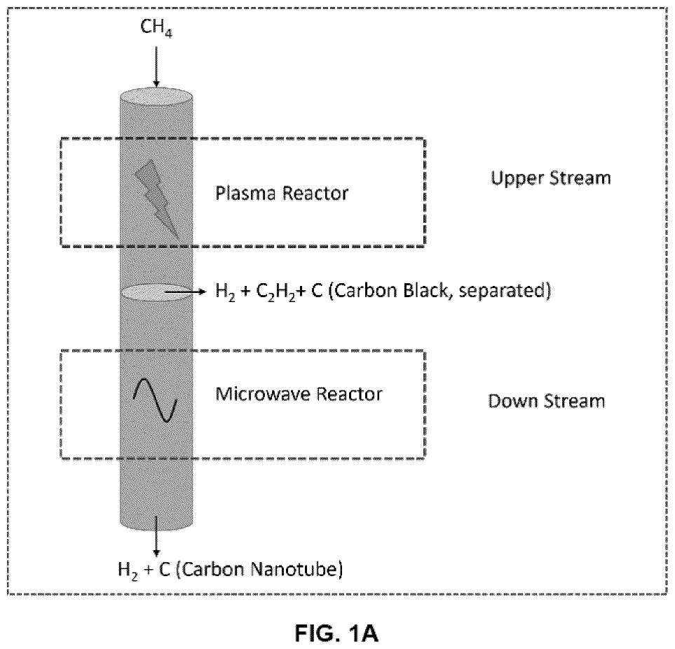

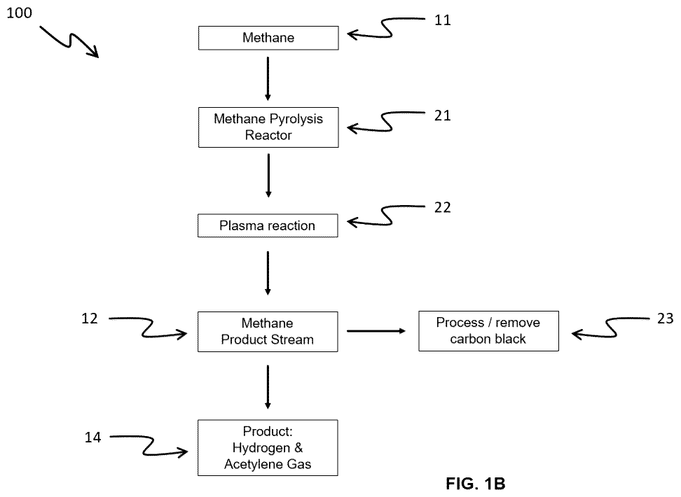

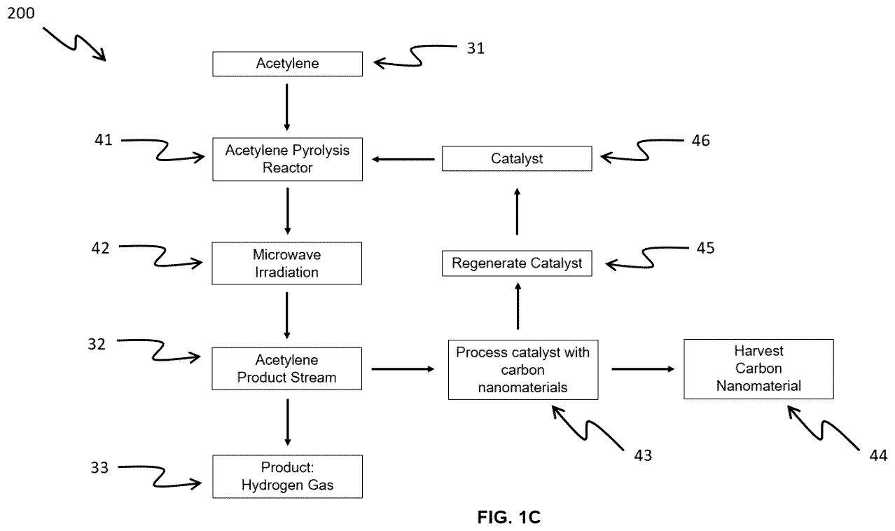

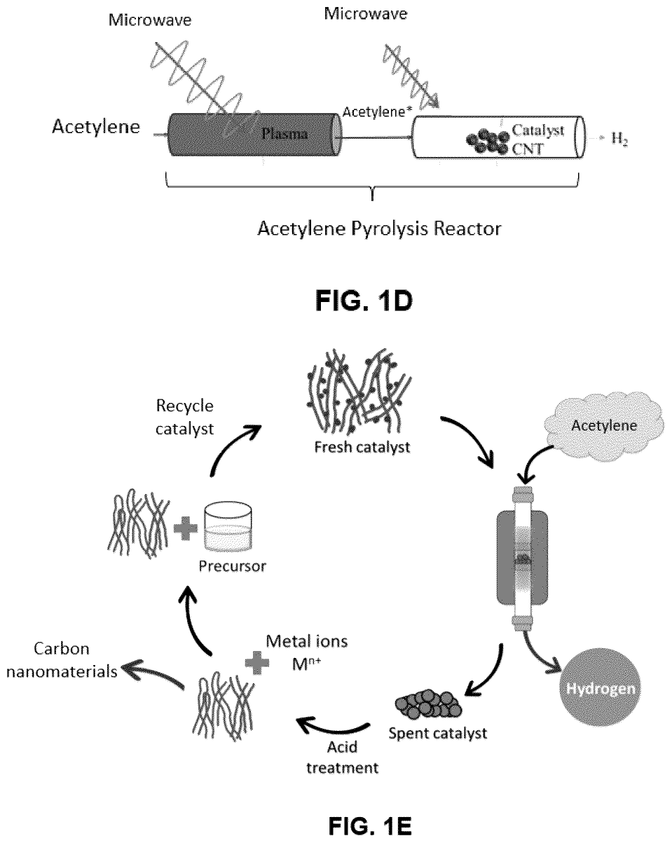

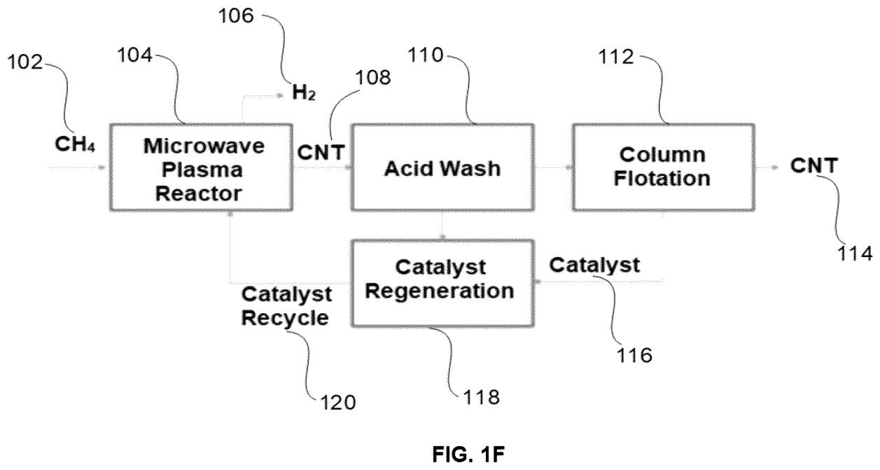

Referring now to FIGS. 1A-1F, various further aspects of the disclosed methods, processes, and devices will be discussed. FIG. 1A-1E show schematic representations and flow diagrams of a disclosed methods and processes. An overall work- and product-flow from plasma pyrolysis of methane to product of hydrogen and by-products such as acetylene through the conversion of this by-product using the disclosed methods, processes, and devices is shown in FIG. 1A, and details of the conversion of acetylene using the disclosed methods is shown in FIGS. 1B-1E. In particular, FIG. 1A shows a disclosed processes integrating the disclosed methods for conversion of acetylene with plasma pyrolysis of methane wherein gasesous products, including hydrogen and by-product gases such as acetylene, are directed to a system and device for carrying out the disclosed methods and processes. FIG. 1B shows a flow diagram for a plasma pyrolysis of methane, such as conventional methods of plasma pyrolysis, which as shown in FIG. 1A, can be directly integrated with the disclosed methods and processes. FIG. 1C shows a flow diagram for a disclosed method of converting acetylene to hydrogen and carbon nanomaterials. FIG. 1D shows a disclosed two stage acetylene pyrolysis reactor comprising a first stage of microwave irradiation of input gases comprising acetylene, and a second stage comprising a catalyst bed comprising a disclosed catalyst, wherein the catalyst bed is irradiated with microwave energy.

FIG. 1E shows a schematic representation of a disclosed process. An overall work- and product-flow from plasma pyrolysis of methane to product of hydrogen and by-products such as acetylene through the conversion of this by-product using the disclosed methods, processes, and devices is shown in FIG. 1A, and details of the conversion of acetylene using the disclosed methods is shown in FIGS. 1B-1E.

FIG. 1A shows a representative illustration of a disclosed method comprising a first step, or upper stream, comprising plasma pyrolysis of methane to yield gaseous products, such as hydrogen, and gaseous by-products comprising acetylene, and solid carbon materials. The gaseous products and by-products of the upper stream can be conveyed directly into the second step, or down stream, wherein acetylene—a principal gaseous by-product of the upper stream—undergoes catalytic conversion with microwave irradiation to provide further hydrogen and carbon nanomaterials.

FIG. 1B shows a flow diagram for a representative conventional process for plasma pyrolysis of methane 100 to provide solid carbon products 23 comprising polycyclic aromatic hydrocarbon and gaseous products 14 comprising hydrogen and by-product gases such as acetylene, ethylene, and benzene. Briefly, a source of methane 11 is provided into the process, e.g., natural gas, and conveyed to a methane pyrolysis reactor 21 and undergoes plasma pyrolysis 22, thereby yielding a methane product stream comprising, as described immediately above, solid carbon products 23 comprising polycyclic aromatic hydrocarbon and gaseous products 14 comprising hydrogen and by-product gases such as acetylene, ethylene, and benzene. The process for plasma pyrolysis of methane 100 can be located near or proximate to a field site that extracts methane, e.g., fracking at a field site. Alternatively, the natural gas comprising principally methane can be conveyed from a field site to a centralized methane processing site, e.g., via a pipeline, comprising a one or more methane pyrolysis reactor systems for large scale processing of methane from one or more field sites.

FIG. 1C shows a flow diagram for a representative disclosed process for conversion of acetylene 200. In the disclosed process for conversion of acetylene 200 a source of acetylene 31 is conveyed to an acetylene pyrolysis reactor 41 comprising at least one catalyst bed and a microwave generator capable of providing microwave energy for microwave irradiation of the catalyst bed 42. As discussed herein above, the acetylene source can be the gaseous product and by-products from the representative conventional process for plasma pyrolysis of methane 100. Thus, in various aspects, the gaseous product stream from process 100 can be conveyed directly to process 200 without separation of the gaseous product and by-products, i.e., the complete gaseous mixture comprising hydrogen, acetylene, and any other gaseous by-products from process 100 is conveyed directly into the feedstream for process 200. In other aspects, the gaseous product stream from process 100 can be stored or transported, e.g., via pipeline, tanker car, or tanker truck, from a site comprising the process 100 to a distinct site for processing via process 200.

Microwave irradiation 42 heats the catalyst to an appropriate temperature as discussed herein above, thereby initiating a reaction for pyrolytic conversion of acetylene to hydrogen and carbon nanomaterials, i.e., the acetylene product stream 32 comprising carbon nanomaterials disposed on or about the catalyst in the catalyst bed of the acetylene pyrolysis reactor 43 and a gaseous product stream comprising hydrogen 33. The carbon nanomaterials 44 can be isolated or removed from the catalyst concomitant with regeneration of the catalyst material 45 thereby generating regenerated catalyst 46 that can be reused in the acetylene pyrolysis reactor 41. The carbon nanomaterials 44 can also be harvested from the catalyst by mechanical milling methods such as attrition milling methods.

FIG. 1D shows a schematic illustration of a disclosed two stage acetylene pyrolysis reactor comprising a first stage wherein microwave irradiation can be used to heat or activate the process feed gas, i.e., acetylene, and then conveyed to the second stage wherein microwave irradiation can further heat the process feed gas, i.e., acetylene, and directly heat the catalyst material in the catalyst bed, thereby producing a gaseous product comprising hydrogen and carbon nanomaterials comprising carbon nanotubes and other carbon nanomaterials.

FIG. 1E shows a schematic illustration of a representative disclosed process for conversion of acetylene, such as that described in detail herein above and in FIG. 1B.

FIG. 1F shows an exemplary process as disclosed herein. Methane stream 102 is fed into microwave plasma reactor 104 and produces hydrogen 106 during the course of the reaction, as well as carbon nanotubes 108. CNT 108 are washed with acid in acid wash unit 110, fed through flotation column 112, and some or all CNT 114 are extracted from the flotation column 112. Separately, catalyst 116 is removed from the flotation column 112, or transferred directly from acid wash unit 110, resulting in catalyst regeneration 118. A catalyst recycling 120 step has thus been completed, and the catalyst is ready to be placed into microwave plasma reactor 104 for another reaction round.

### D. MICROWAVE REACTOR AND PROCESS

In one aspect, the disclosed methods utilize a reactor system, wherein the reactor system comprises a variable frequency microwave reactor system. In a further aspect, the reactor can be a fluidized bed reactor. In another aspect, the reactor can have a cavity from about 915 MHz to about 20 GHz, or of about 915, 950, or 975 MHz, or 1, 2, 3, 4, 5, 6, 7, 8, 9, 10, 11, 12, 13, 14, 15, 16, 17, 18, 19, or about 20 GHz, or a combination of any of the foregoing values, or a range encompassing any of the foregoing values. In another aspect, the reactor can be operated in a system having a variable frequency from about 5.85 to about 8.25 GHz. In a further aspect, the reactor can be operated in a system having a variable frequency from about 5.85 to about 6.85 GHz. In one aspect, a cavity that is lower (i.e., 915 MHz) can allow for scaling of the reaction to high power (>50 kW) generators for industrial use. In any of the above aspects, the reactor cavity is designed for extending a uniform microwave field through the length of an inner quartz reactor tube. In one aspect, the microwave generator can be from about 200 W to about 10 MW, or at about 200, 400, 600, or 800 W, or about 1, 10, 15, 20, 25, 30, 35, 40, 45, 50, 55, 60, 65, 70, 75, 80, 85, 90, or 95 kW, or about 1, 2, 3, 4, 5, 6, 7, 8, 9, or 10 MW, or a combination of any of the foregoing values, or a range encompassing any of the foregoing values.

In one aspect, the microwave reactor can be modular. In a further aspect, modular design allows adjustments of geometry to control gas flows and fluidization to accommodate changes in gas velocities and power inputs. In a still further aspect, when the microwave reactor has two stages, the first stage reactor can decouple acetylene activation from the conventional catalytic surface reaction. In another aspect, the second stage can be a variable frequency microwave catalytic reactor, which can incorporate dipolar and/or Debye processes as discussed herein. A schematic of a two-stage acetylene pyrolysis reactor can be seen in FIG. 1D.

In one aspect, introduction of a microwave catalytic plasma source can reduce the energy required to dissociate hydrogen from various hydrogen-containing compounds such as, for example, methane gas. In another aspect, a microwave plasma source is electrodeless but can still produce a high degree of ionization.

In one aspect, space velocity, metal loading on catalyst, temperature, pressure, microwave power, and microwave frequency are expected to affect the lengths, diameters, and wall thicknesses of any CNT and/or CNF produced by the disclosed reactions. In another aspect, the method disclosed herein is performed at from about 1 to about 20 atm, or at about 1, 2, 3, 4, 5, 6, 7, 8, 9, 10, 11, 12, 13, 14, 15, 16, 17, 18, 19, or about 20 atm, or a combination of any of the foregoing values, or a range encompassing any of the foregoing values.

In one aspect, introduction of a disclosed microwave reactor can reduce the energy required to dissociate hydrogen from various hydrogen-containing compounds and produce carbon nanomaterials such as, for example, acetylene.

In one aspect, space velocity, metal loading on catalyst, temperature, pressure, microwave power, and microwave frequency are expected to affect the lengths, diameters, and wall thicknesses of any CNT and/or CNF produced by the disclosed reactions. In another aspect, the method disclosed herein is performed at from about 1 to about 20 atm, or at about 1, 2, 3, 4, 5, 6, 7, 8, 9, 10, 11, 12, 13, 14, 15, 16, 17, 18, 19, or about 20 atm, or a combination of any of the foregoing values, or a range encompassing any of the foregoing values.

### E. CATALYST FOR THE DISCLOSED METHODS

In one aspect, the catalytic materials useful herein have dielectric properties that allow microwave absorption, especially at higher temperatures. In a further aspect, the catalysts can be designed to interact with microwaves through other mechanisms. In one aspect, a metal dopant such as, for example, iron, can be added to catalytic sites for magnetic coupling. In one aspect, a ferromagnetic species can couple with the magnetic component of the microwave field, adding energy to the reaction. In a further aspect, coupling of the microwave field with polar intermediate species on the surface of the catalyst can increase the amount of energy available for the reaction.

In one aspect, the catalyst can be supported. In a further aspect, the catalyst can be supported by an aerogel. In a yet further aspect, the aerogel can be an Al₂O₃ aerogel. In a still further aspect, when the catalyst is an Al₂O₃ aerogel, the catalyst can be a Ni catalyst or a Ni—Pd catalyst. In an even further aspect, the catalyst comprises Ni—Pd and an Al₂O₃ aerogel support, wherein the ratio of Ni:Pd:support is from about 8:1:91 to about 12:1:87, or is about 8:1:91, 9:1:90, 10:1:89, 11:1:88, or about 12:1:87, or a combination of any of the foregoing values, or a range encompassing any of the foregoing values. In one aspect, the ratio of Ni:Pd:support is about 10:1:89.

In a further aspect, the catalyst can be supported by a carbon nanomaterial. In a still further aspect, the catalyst support can comprise by carbon nanomaterials formed in the disclosed methods. In a yet further aspect, when the support is a crystalline form of carbon, the support can be selected from nanoparticles, fullerenes, carbon filaments, single-walled carbon nanotubes, multi-walled carbon nanotubes, carbon nanofibers, or a combination thereof.

In a further aspect, the disclosed catalysts, whether supported or unsupported, can be monometallic. In a still further aspect, the disclosed catalysts, whether supported or unsupported, are monometallic and comprise Ni.

In a further aspect, the disclosed catalysts, whether supported or unsupported, can be bimetallic. In one aspect, the bimetallic catalyst can be a Ni—Pd catalyst. In another aspect, the Ni—Pd catalyst can be doped by an alkali metal, an alkaline earth metal, or a transition metal including, but not limited to, Fe, Li, Na, K, Cs, Mg, Ca, Ba, or a combination thereof. In one aspect, the addition of an alkali metal, alkaline earth metal, or transition metal can promote catalyst structure, modify active metal dispersion, and/or promote hydrogen spillover.

In one aspect, certain catalysts are expected to display higher levels of acetylene conversion under microwave heating versus conventional thermal heating. In a further aspect, these catalysts include, but are not limited to aerogel catalysts including monometallic or bimetallic such as Ni, Ni—Pd, either unsupported, on CNT or CNF support, on Al₂O₃ supporting, including Al₂O₃ aerogel support, and combinations thereof.

Disclosed herein are methods for making an aerogel-supported catalyst useful for microwave-assisted conversion of methane, the method comprising: (a) admixing a catalyst precursor compound and an aerogel precursor compound to create a first mixture; (b) adding a first solvent to the first mixture to create a second mixture; (c) agitating the second mixture for a first time period; (d) heating the second mixture at a first temperature for a second time period; (e) cooling the second mixture to a second temperature; (f) adding a gelation agent to the second mixture to form a third mixture; (g) incubating the third mixture at a third temperature for a third time period; (h) washing the third mixture with a second solvent; (i) soaking the third mixture with a third solvent for a fourth time period; and (j) vacuum drying the third mixture for a fifth time period.

In a further aspect, the catalyst precursor compound can be Ni(NO₃)₂·6H₂O, Pd(NO₃)₂·6H₂O, or any combination thereof. In still another aspect, the aerogel precursor compound can be AlCl₃-6H₂O.

In a further aspect, the first solvent can be water, ethanol, or a combination thereof, and the first time period is about from about 30 to about 45 min, or can be about 30 min. In another aspect, the first temperature is from about 75 to about 85° C., or can be about 80° C. In one aspect, the second time period is from about 1 h to about 1.5 h, or can be about 1 h. In another aspect, the second temperature is from about −5 to about 0° C., or can be about 0° C. In one aspect, the gelation agent can be propylene oxide, ethylene glycol, hexylene glycol, or a combination thereof. In still another aspect, the third temperature can be from about 20 to about 30° C., or can be about 20° C. In one aspect, the third time period is from about 30 to about 50 min, or can be about 35 min. In one aspect, the second solvent can be water and the third solvent can be ethanol. In another aspect, the fourth time period is from about 11 to about 13 h, or can be about 12 h and the fifth time period is from about 8 to about 10 h, or can be about 9 h.

In a further aspect, when the aerogel-supported catalyst is Ni/Al₂O₃, the method further includes step (h1): reducing the catalyst at a fourth temperature for a sixth time period. In one aspect, the fourth temperature is from about 465 to about 475° C. or is about 470° C. and the sixth time period is from about 2.5 to about 3 h, or can be about 2.5 h.

Ratio of Metals in Catalyst. In some aspects, different metal ratios (by weight) can be used in the supported and/or unsupported catalysts disclosed herein. In a further aspect, altering the ratio of metals (such as, for example, Ni and Pd) can alter the catalytic performance of the system. In one aspect, pure Ni can be used as catalyst. In another aspect, pure Pd can be used as catalyst. In still another aspect, a different metal can be used as catalyst. In one aspect, the ratio of Ni to Pd can be 20:1, 15:1, 10:1, 5:1, 1:1, or another ratio, or a combination of any of the foregoing values, or a range encompassing any of the foregoing values. In one aspect, the ratio of Ni to Pd is 10:1. In another aspect, the ratio of Ni to Pd is 5:1. Without wishing to be bound by theory, it is believed the metals in the solid solution of Ni and Pd have synergistic catalytic effects that are only achieved when a minimum concentration of Pd is present.

In one aspect, different catalyst metal compositions may have different average particle sizes that can be determined by examination with an electron microscope. In one aspect, for a Ni/CNT catalyst, round metal particles with an average diameter from about 50 to about 100 nm, or about 50, 60, 70, 80, 90, or about 100 nm are observed. In another aspect, for an unsupported Ni catalyst, large agglomerates with diameters of hundreds of nm (with some upwards of 500 nm) are observed. In another aspect, for a Pd/CNT catalyst, the average metal particle size is about 5 nm. In one aspect, with increased amounts of Ni versus Pd in unsupported catalysts, more agglomeration is observed. In one aspect, the same effects may not be observed for CNT-supported catalysts. Without wishing to be bound by theory, the presence of CNT or other supports may aid in distribution of the metal catalyst particles such that agglomeration does not occur. In any of the above aspects, catalyst particles with average diameters on the order of about 50 to about 100 nm that do not agglomerate may be the most effective at enabling and/or enhancing the disclosed processes. In any of the above aspects, agglomeration may be associated with sintering behavior (i.e., coalescence into a solid mass). In one aspect, catalysts that resist sintering may be particularly effective at enabling and/or enhancing the disclosed processes.

Catalyst Recycling. Commercially-available catalysts, especially those that are oxide-supported, are difficult to recover when dissolved in organic or inorganic solution. In one aspect, provided herein is a method for recycling and recovering the catalysts disclosed herein. In one aspect, although the catalysts disclosed herein exhibit excellent reproducibility in terms of hydrogen generation over time, they will eventually become spent or deactivated and will need to be regenerated or recycled. In another aspect, the method disclosed herein can be useful in regenerating or recycling the catalysts disclosed herein. In one aspect, spent catalysts can be refluxed with an acid such as, for example, nitric acid. In a further aspect, reflux can be carried out in one step or may require two steps, each with a different concentration of acid. In one aspect, the spent catalyst can be refluxed with nitric acid at a concentration of from 0.01 M to 15.7 M, or from about 0.5 M to 10 M, or from 0.5 M to 5 M, or the nitric acid concentration can be about 0.01, 0.05, 0.1, 0.5, 1, 1.5, 2, 2.5, 3, 3.5, 4, 4.5, 5, 5.5, 6, 6.6, 7, 7.5, 8, 8.5, 9, 9.5, 10, 10.5, 11, 11.5, 12, 12.5, 13, 13.5, 14, 14.5, 15, 15.5, or about 15.7 M, or a combination of any of the foregoing values, or a range encompassing any of the foregoing values. In another aspect, the spent catalyst can be refluxed at from about 25° C. to about 250° C., or from about 30° C. to about 140° C., or from about 40° C. to about 120° C., or can be refluxed at about 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, or about 250° C., or a combination of any of the foregoing values, or a range encompassing any of the foregoing values. In still another aspect, reflux can be conducted for from about 0.5 to about 36 hours, or from about 0.5 to about 24 hours, or from about 1 to about 18 hours, or for about 0.5, 1, 1.5, 2, 2.5, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, or about 36 hours, or a combination of any of the foregoing values, or a range encompassing any of the foregoing values. In one aspect, the spent catalyst can be refluxed with 3 M HNO₃ at 120° C. for 4 h, followed by reflux with concentrated HNO₃ at 140° C. for 12 h. In some aspects, dilute nitric acid can be used for either of these reflux steps. In one aspect, the nitric acid can have a concentration from about 0.1 M to about 15.8 M, or is about 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, or about 15.8 M or a combination of any of the foregoing values, or a range encompassing any of the foregoing values. In one aspect, reflux is conducted with continuous magnetic stirring.

In another aspect, following reflux, solid carbon particles and nanostructures can be filtered and washed with a solvent such as, for example, deionized water. In one aspect, when the metals are dissolved in acid solutions, they re-form metal counter-ion precursors, wherein the counter-ions are sourced from the acids. Thus, further in this aspect, the following scheme for nickel in nitric acid is generalizable to other metals and acids with stoichiometries determined based on metal oxidation state and counter-ion charge:

Ni+4HNO₃→Ni(NO₃)₂+2NO₂+2H₂O.

In one aspect, the carbon particles can be dried at elevated temperature such as, for example, at 80° C. Following drying, in another aspect, a portion of the carbon particles can be used in the next catalytic cycle. In one aspect, from about 1 to about 99 wt % of the carbon particles can be used in the next catalytic cycle, or from about 5 to about 90 wt % of the carbon particles can be used in the next catalytic cycle, or from about 10 to about 50% of the carbon particles can be used in the next catalytic cycle, or about 1, 5, 10, 15, 20, 25, 30, 35, 40, 45, 50, 55, 60, 65, 70, 75, 80, 85, 90, 95, or about 99 wt % of the carbon particles can be used in the next catalytic cycle, or a combination of any of the foregoing values, or a range encompassing any of the foregoing values.

In some aspects, Raman spectroscopy can be used to evaluate the compositions disclosed herein after 1, 2, 3 4, 5, or more cycles of use. In some aspects, the “ID/IG” ratio can be used as a basis for estimating amount of structured versus unstructured carbon in a sample. In one aspect, the D band is reflective of disordered structure and is located between about 1300 and about 1400 cm⁻¹ and the G band is reflective of content of sp² hybridized carbon (i.e., ordered) and is located between about 1500 and about 1600 cm⁻¹, although these values can vary slightly based on particular aspects of the samples being analyzed. ID/IG ratio is most helpful when comparing similar samples such as, for example, catalyst/CNT compositions after one or more use cycles as disclosed herein. A relatively higher ID/IG ratio (i.e., comparison of relative peak areas) indicates a larger proportion of disordered carbon is present in a sample, while a relatively lower ID/IG ratio indicates a larger proportion of structured or sp² hybridized carbon is present. An unchanged ID/IG between different treatments indicates the proportions of structured and unstructured carbon are essentially unchanged between treatments.

### F. CARBON NANOMATERIAL PRODUCTS

In one aspect, during the catalyst recycling step described herein, a portion of the solid carbon from the reaction vessel is retained as a support for the next catalytic cycle. Further in this aspect, since nanostructured carbon is a product of the reactions disclosed herein, some amount of excess carbon will be available after catalyst recycling. Still further in this aspect, this excess carbon is already purified and dried due to processing in the catalyst recovery step and can be further characterized by any means known in the art including, but not limited to, electron microscopy to evaluate structure, width, and length, X-ray diffraction and/or Raman spectroscopy to assess crystallinity, thermogravimetric analysis to assess whether any amorphous carbon is present, and similar techniques.

In some aspects, the CNT and CNF that are produced are single-walled. In other aspects, multiwalled carbon nanotubes (MWCNT) may be produced. In one aspect, MWCNT have a diameter close to the particle size of Ni on CNT support. Without wishing to be bound by theory, a Ni/CNT catalyst may be particularly effective at forming MWCNT.

In one aspect, the carbon nanomaterials, such as crystalline carbon (i.e., CNTs and CNFs), generated from the disclosed methods can be used as intermediates to make carbon fibers, carbon composites, and electrodes useful for electric arc steel production. In another aspect, CNT and CNF may be useful for the production of integrated circuits, hydrogen storage devices, lithium batteries, solar photovoltaic cells, fuel cells, drug delivery, and other applications. In a further aspect, the processes disclosed herein can produce both single-walled and multi-walled CNTs.

### G. ADVANTAGES OF MICROWAVE HEATING OVER CONVENTIONAL HEATING

In one aspect, the disclosed methods utilized microwave heating and provide a method for conversion of acetylene that is more energy efficient than conventional heating. In a further aspect, applied energy from microwave heating concentrates on catalyst sites (e.g., metal clusters) and is thus selective, with metal parts of the catalyst acting as “hot spots” while the support maintains a lower temperature. Further in this aspect, the acetylene decomposition reaction takes place in the areas directly adjacent to the hot spots. In an alternative aspect, conventional heating operates through a convective heat transfer process that is indiscriminate with respect to gas feed, reactor, and catalyst. In an alternative aspect, heat transfer is from an external furnace to the reactor wall, then to catalyst support before active sites are heated up, whereas the microwave reactor can deliver electromagnetic energy to active sites directly, thereby achieving an energy savings. In a further aspect, waste heat from catalyst regeneration can be used to preheat feedstock, reserving the need for microwave energy for C—H bond activation only.

In another aspect, microwave heating can be turned on or off, whereas conventional heating requires time to heat up or cool down. Without wishing to be bound by theory, in one aspect, the electric field of the microwave creates dipoles on the catalyst surface through a relaxation process that, in turn, facilitates the decomposition of acetylene. In an alternative aspect, conventional heating does not have this effect. In another aspect, microwave heating increases the pre-exponential factor in the Arrhenius equation model of acetylene decomposition, leading to a higher reaction rate and facilitating decomposition, whereas conventional heating does not have this effect.

In a further aspect, the properties of the CNTs/CNFs produced, such as, for example, length, diameter, and wall thickness are sensitive to microwave power input and frequency and are thus more tunable under microwave heating than under conventional heating. In one aspect, longer CNTs can be produced under microwave conditions versus non-microwave conditions.

In one aspect, microwave heating avoids the problem of metal sintering using conventional heating. Further in this aspect, due to the decoupling of methane activation from catalyst surface reaction, the microwave-activated species can react on the catalyst surface to form CNTs and hydrogen under less severe conditions.

In another aspect, one of the mechanisms by which the catalyst and reacting species can interact with the microwave field and provide energy to the reaction is through relaxation processes. In a further aspect, these relaxations include dipolar or Debye processes, which involve the coupling of the radiation with dipoles in the solid catalyst. In a further aspect, these dipoles can be defect sites (i.e., atomic vacancies) in the catalysts or dangling bonds on the surface of the catalyst. In a further aspect, dipoles on the catalyst surface can be reactants or products susceptible to selective bond activation effects which, in turn, can affect reaction rates.

In a further aspect, the microwave radiation induces a temperature in the catalyst from about 300 to about 500° C., or from about 350 to about 500° C., or of about 300, 350, 400, 450, or about 500° C., or a combination of any of the foregoing values, or a range encompassing any of the foregoing values.

### H. REFERENCES

References are cited herein throughout using the format of reference number(s) enclosed by parentheses corresponding to one or more of the following numbered references, e.g. “(Ref. 1)”. For example, citation of references numbers 1 and 2 immediately herein below would be indicated in the disclosure as “(Refs. 1 and 2)”.
Ref 1. G. Chen, X. Tu, G. Homm, A. Weidenkaff, Plasma pyrolysis for a sustainable hydrogen economy, Nat. Rev. Mater. 7 (2022) 333-334.
Ref 2. F. Kerscher, A. Stary, S. Gleis, A. Ulrich, H. Klein, H. Spliethoff, Low-carbon hydrogen production via electron beam plasma methane pyrolysis: Techno-economic analysis and carbon footprint assessment, Int. J. Hydrogen Energy. 46 (2021) 19897-19912.
Ref 3. M. Dors, H. Nowakowska, M. Jasinski, J. Mizeraczyk, Chemical kinetics of methane pyrolysis in microwave plasma at atmospheric pressure, Plasma Chem. Plasma Process. 34 (2014) 313-326.
Ref 4. J. R. Fincke, R. P. Anderson, T. Hyde, B. A. Detering, R. Wright, R. L. Bewley, D. C. Haggard, W. D. Swank, Plasma Thermal Conversion of Methane to Acetylene, Plasma Chem. Plasma Process. 22 (2002) 105-136.
Ref 5. S. Takenaka, M. Serizawa, K. Otsuka, Formation of filamentous carbons over supported Fe catalysts through methane decomposition, J. Catal. 222 (2004) 520-531.
Ref 6. M. A. Ermakova, D. Y. Ermakov, Ni/SiO2 and Fe/SiO2 catalysts for production of hydrogen and filamentous carbon via methane decomposition, Catal. Today. 77 (2002) 225-235.
Ref 7. Y. Zhang, K. J. Smith, Carbon formation thresholds and catalyst deactivation during CH4 decomposition on supported Co and Ni catalysts, Catal. Letters. 95 (2004) 7-12.
Ref 8. K. R. Parmar, K. K. Pant, S. Roy, Blue hydrogen and carbon nanotube production via direct catalytic decomposition of methane in fluidized bed reactor: Capture and extraction of carbon in the form of CNTs, Energy Convers. Manag. 232 (2021) 113893.
Ref 9. N. Senchez-Bastardo, R. Schlögl, H. Ruland, Methane Pyrolysis for Zero-Emission Hydrogen Production: A Potential Bridge Technology from Fossil Fuels to a Renewable and Sustainable Hydrogen Economy, Ind. Eng. Chem. Res. 60 (2021) 11855-11881.
Ref 10. I. Wang, R. A. Dagle, T. S. Khan, J. A. Lopez-Ruiz, L. Kovarik, Y. Jiang, M. Xu, Y. Wang, C. Jiang, S. D. Davidson, P. Tavadze, L. Li, J. Hu, Catalytic decomposition of methane into hydrogen and high-value carbons: combined experimental and DFT computational study, Catal. Sci. Technol. 11 (2021) 4911-4921.
Ref 11. C. Jiang, I. W. Wang, X. Bai, S. Balyan, B. Robinson, J. Hu, W. Li, A. Deibel, X. Liu, F. Li, L. M. Neal, J. Dou, Y. Jiang, R. Dagle, J. A. Lopez-Ruiz, G. Skoptsov, Methane Catalytic Pyrolysis by Microwave and Thermal Heating over Carbon Nanotube-Supported Catalysts: Productivity, Kinetics, and Energy Efficiency, Ind. Eng. Chem. Res. 61 (2022) 5080-5092.
Ref 12. E. M. Khabushev, D. V. Krasnikov, A. E. Goldt, E. O. Fedorovskaya, A. P. Tsapenko, Q. Zhang, E. I. Kauppinen, T. Kallio, A. G. Nasibulin, Joint effect of ethylene and toluene on carbon nanotube growth, Carbon N. Y. 189 (2022) 474-483.
Ref 13. C. Zhuo, H. Richter, Y. A. Levendis, Carbon Nanotube Production from Ethylene in CO2/N2 Environments, J. Energy Resour. Technol. Trans. ASME. 140 (2018) 1-8.
Ref 14. T. Hiraoka, T. Kawakubo, J. Kimura, R. Taniguchi, A. Okamoto, T. Okazaki, T. Sugai, Y. Ozeki, M. Yoshikawa, H. Shinohara, Selective synthesis of double-wall carbon nanotubes by CCVD of acetylene using zeolite supports, Chem. Phys. Lett. 382 (2003) 679-685.
Ref 15. M. Perez-Cabero, I. Rodriguez-Ramos, A. Guerrero-Ruiz, Characterization of carbon nanotubes and carbon nanofibers prepared by catalytic decomposition of acetylene in a fluidized bed reactor, J. Catal. 215 (2003) 305-316.
Ref 16. G. Zhong, S. Hofmann, F. Yan, H. Telg, J. H. Warner, D. Eder, C. Thomsen, W. I. Milne, J. Robertson, Acetylene: A key growth precursor for single-walled carbon nanotube forests, J. Phys. Chem. C. 113 (2009) 17321-17325.
Ref 17. G. Eres, C. M. Rouleau, M. Yoon, A. A. Puretzky, J. J. Jackson, D. B. Geohegan, Model for self-assembly of carbon nanotubes from acetylene based on real-time studies of vertically aligned growth kinetics, J. Phys. Chem. C. 113 (2009) 15484-15491.
Ref 18. S. C. Lyu, B. C. Liu, C. J. Lee, H. K. Kang, C. W. Yang, C. Y. Park, High-quality double-walled carbon nanotubes produced by catalytic decomposition of benzene, Chem. Mater. 15 (2003) 3951-3954.
Ref 19. D. C. Lee, F. V. Mikulec, B. A. Korgel, Carbon Nanotube Synthesis in Supercritical Toluene, J. Am. Chem. Soc. 126 (2004) 4951-4957.
Ref 20. R. T. K. Baker, M. A. Barber, P. S. Harris, F. S. Feates, R. J. Waite, Nucleation and growth of carbon deposits from the nickel catalyzed decomposition of acetylene, J. Catal. 26 (1972) 51-62.
Ref 21. S. Delpeux, K. Szostak, E. Frackowiak, S. Bonnamy, F. Beguin, High yield of pure multiwalled carbon nanotubes from the catalytic decomposition of acetylene on in situ formed cobalt nanoparticles, J. Nanosci. Nanotechnol. 2 (2002) 481-484.
Ref 22. K. Otsuka, S. Kobayashi, S. Takenaka, Catalytic decomposition of light alkanes, alkenes and acetylene over Ni/SiO₂, Appl. Catal. A Gen. 210 (2001) 371-379.
Ref 23. G. Do Lee, S. Han, J. Yu, J. Ihm, Catalytic decomposition of acetylene on Fe(001): A first-principles study, Phys. Rev. B—Condens. Matter Mater. Phys. 66 (2002) 1-4.
Ref 24. X. Jian, M. Jiang, Z. Zhou, M. Yang, J. Lu, S. Hu, Y. Wang, D. Hui, Preparation of high purity helical carbon nanofibers by the catalytic decomposition of acetylene and their growth mechanism, Carbon N. Y. 48 (2010) 4535-4541.
Ref 25. R. T. K. Baker, P. S. Harris, R. B. Thomas, R. J. Waite, Formation of filamentous carbon from iron, cobalt and chromium catalyzed decomposition of acetylene, J. Catal. 30 (1973) 86-95.
Ref 26. V. A. Labunov, A. S. Basaev, B. G. Shulitski, Y. P. Shaman, I. Komissarov, A. L. Prudnikava, B. K. Tay, M. Shakerzadeh, Growth of few-wall carbon nanotubes with narrow diameter distribution over fe-mo-mgo catalyst by methane/acetylene catalytic decomposition, Nanoscale Res. Lett. 7 (2012) 1-8.
Ref 27. X. Ren, H. Zhang, Z. Cui, Acetylene decomposition to helical carbon nanofibers over supported copper catalysts, Mater. Res. Bull. 42 (2007) 2202-2210.
Ref 28. Y. Qin, Q. Zhang, Z. Cui, Effect of synthesis method of nanocopper catalysts on the morphologies of carbon nanofibers prepared by catalytic decomposition of acetylene, J. Catal. 223 (2004) 389-394.
Ref 29. R. T. K. Baker, R. J. Waite, Formation of carbonaceous deposits from the platinum-iron catalyzed decomposition of acetylene, J. Catal. 37 (1975) 101-105.
Ref 30. A. Dominguez, B. Fidalgo, Y. Fernández, J. J. Pis, J. A. Menéndez, Microwave-assisted catalytic decomposition of methane over activated carbon for CO2-free hydrogen production, Int. J. Hydrogen Energy. 32 (2007) 4792-4799.
Ref 31. B. Eryildirim, H. Arbag, N. Oktar, G. Dogu, Comparison of microwave and conventionally heated reactor performances in catalytic dehydrogenation of ethane, Int. J. Hydrogen Energy. 46 (2021) 5296-5310.
Ref 32. D. D. Eslek Koyuncu, Microwave-assisted non-oxidative ethane dehydrogenation over different carbon materials, Diam. Relat. Mater. 110 (2020) 108130.
Ref 33. A. K. M. Fazle Kibria, Y. H. Mo, K. S. Nahm, M. J. Kim, Synthesis of narrow-diameter carbon nanotubes from acetylene decomposition over an iron-nickel catalyst supported on alumina, Carbon N. Y. 40 (2002) 1241-1247.
Ref 34. Y. H. Mo, A. K. M. F. Kibria, K. S. Nahm, The growth mechanism of carbon nanotubes from thermal cracking of acetylene over nickel catalyst supported on alumina, Synth. Met. 122 (2001) 443-447.
Ref 35. T. Kim, J. Lee, K. H. Lee, Microwave heating of carbon-based solid materials, Carbon Lett. 15 (2014) 15-24.
Ref 36. M. Vázquez, E.; Prato, Carbon Nanotubes and Microwaves, ACS Nano. 3 (2009) 3819-3824.

### I. ASPECTS

The following listing of exemplary aspects supports and is supported by the disclosure provided herein.

Aspect 1. A method for producing hydrogen and carbon nanomaterials from acetylene, the method comprising: (a) applying microwave radiation to the acetylene in the presence of a catalyst comprising metal atoms, wherein the microwave radiation causes the acetylene to decompose into hydrogen and at least one solid carbon product; (b) separating the hydrogen and the at least one solid carbon product.

Aspect 2. The method of 1, further comprising: (c) contacting the catalyst and the at least one solid carbon product with an acid composition, wherein the acid composition causes the metal atoms to separate from the at least one solid carbon product; (d) removing the metal atoms from the acid composition; and (e) removing the at least one solid carbon product from the acid composition.

Aspect 3. The method of Aspect 1 or Aspect 2, wherein the catalyst further comprises a support.

Aspect 4. The method of Aspect 3, wherein the support comprises a supporting solid carbon product, Al₂O₃, or a combination thereof.

Aspect 5. The method of Aspect 4, wherein the Al₂O₃ comprises a Al₂O₃ aerogel.

Aspect 6. The method of Aspect 1, wherein the catalyst is unsupported.

Aspect 7. The method of any of Aspect 1-Aspect 6, wherein the catalyst comprises Ni, Ni—Pd, or a combination thereof.

Aspect 8. The method of Aspect 7, wherein the catalyst is monometallic.

Aspect 9. The method of Aspect 7, wherein the catalyst is bimetallic.

Aspect 10. The method of any of Aspect 1-Aspect 9, wherein the catalyst further comprises a dopant.

Aspect 11. The method of Aspect 10, wherein the dopant comprises an alkali metal, an alkaline earth metal, a transition metal, or a combination thereof.

Aspect 12. The method of Aspect 11, wherein the alkali metal comprises Li, Na, K, Cs or a combination thereof.

Aspect 13. The method of Aspect 11, wherein the alkaline earth metal comprises Mg, Ca, Ba, or a combination thereof.

Aspect 14. The method of Aspect 11, wherein the transition metal comprises Fe.

Aspect 15. The method of any of Aspect 1-Aspect 3, Aspect 7, or Aspect 9-Aspect 14, wherein the catalyst comprises Ni, Ni—Pd, or a combination thereof; and wherein the support comprises a supporting solid carbon product.

Aspect 16. The method of any of Aspect 1-Aspect 3, Aspect 7, or Aspect 9-Aspect 14, wherein the catalyst comprises Ni, Ni—Pd, or a combination thereof; and the catalyst is unsupported.

Aspect 17. The method of any of 1-Aspect 5, Aspect 7, or Aspect 9-Aspect 14, wherein the catalyst comprises Ni, Ni—Pd, or a combination thereof; and the support comprises Al₂O₃.

Aspect 18. The method of any of 1-Aspect 17, wherein the catalyst comprises Ni—Pd and wherein the ratio of Ni:Pd:support is from about 8:1:91 to about 12:1:87; about 9:1:90 to about 12:1:87; about 10:1:89 to about 12:1:87; about 11:1:88 to about 12:1:87; about 8:1:91; about 9:1:90; about 10:1:89; about 11:1:88; or about 12:1:87.

Aspect 19. The method of Aspect 18, wherein the catalyst comprises Ni—Pd and wherein the ratio of Ni:Pd:support is 10:1:89.

Aspect 20. The method of any of Aspect 1-Aspect 18, wherein the solid carbon product and the supporting solid carbon product independently comprise nanoparticles, fullerenes, carbon filaments, single-walled carbon nanotubes, multi-walled carbon nanotubes, carbon nanofibers, or a combination thereof.

Aspect 21. The method of Aspect 20, wherein the solid carbon product and the supporting solid carbon product independently comprise single-walled carbon nanotubes, multi-walled carbon nanotubes, carbon nanofibers, or a combination thereof.

Aspect 22. The method of Aspect 21, wherein the single-walled carbon nanotubes, multi-walled carbon nanotubes, or carbon nanofibers have an outer diameter of from about 10 nm to about 500 nm.

Aspect 23. The method of Aspect 22, wherein the single-walled carbon nanotubes, multi-walled carbon nanotubes, or carbon nanofibers have an outer diameter of from about 15 nm to about 300 nm.

Aspect 24. The method of Aspect 21, wherein the single-walled carbon nanotubes, multi-walled carbon nanotubes, or carbon nanofibers have a length of from about 20 nm to about 50 μm.

Aspect 25. The method of any of Aspect 1-Aspect 24, further comprising step (f): using a portion of the at least one solid carbon product as a supporting solid carbon product to restart the method beginning at step (a).

Aspect 26. The method of Aspect 25, wherein from about 5 wt % to about 90 wt % of the solid carbon product is used to restart the method at step (a).

Aspect 27. The method of Aspect 25, wherein from about 10 wt % to about 50 wt % of the solid carbon product is used to restart the method at step (a).

Aspect 28. The method of any of Aspect 1-Aspect 27, wherein in step (c), the acid composition comprises nitric acid.

Aspect 29. The method of Aspect 28, wherein the nitric acid is from 0.5 to 12 M.

Aspect 30. The method of Aspect 28, wherein the nitric acid is 2.5-4 M.

Aspect 31. The method of Aspect 28, wherein step (c) is carried out for 3-5 hours at a temperature of 110-130° C.

Aspect 32. The method of Aspect 28, wherein following step (c), the solid carbon product and the catalyst are contacted with a second acid composition.

Aspect 33. The method of Aspect 32, wherein the second acid composition comprises nitric acid.

Aspect 34. The method of Aspect 33, wherein the second acid composition comprises concentrated nitric acid.

Aspect 35. The method of Aspect 49, wherein the solid carbon product and the catalyst are contacted with the second acid composition for 12 hours at from about 130 to about 150° C.

Aspect 36. The method of any of Aspect 25-Aspect 27, wherein step (f) is repeated at least four times.

Aspect 37. The method of any of Aspect 1-Aspect 36, wherein the method is conducted in an inert atmosphere.

Aspect 38. The method of Aspect 37, wherein the inert atmosphere comprises nitrogen, argon, or a combination thereof.

Aspect 39. The method of Aspect 38, wherein the inert atmosphere comprises nitrogen.

Aspect 40. The method of any of Aspect 1-Aspect 39, wherein the microwave radiation induces a temperature in the catalyst of from about 350 to about 500° C.

Aspect 41. The method of Aspect 40, wherein the microwave radiation induces a temperature in the catalyst of from about 400 to about 500° C.

Aspect 42. The method of any of Aspect 1-Aspect 41, wherein the method is performed at from about 1 to about 20 atm.

Aspect 43. The method of any of Aspect 1-Aspect 42, wherein the microwave radiation is applied at a power of from about 200 W to about 10 MW.

Aspect 44. The method of any of Aspect 1-Aspect 43, wherein the microwave radiation has a frequency of from about 915 MHz to about 20 GHz.

Aspect 45. The method of any of Aspect 1-Aspect 44, wherein the method is carried out for a period of from about 5 to about 800 min.

Aspect 46. The method of any of Aspect 1-Aspect 45, wherein the at least one solid carbon product is produced via a tip growth mechanism, a base growth mechanism, or a combination thereof.

Aspect 47. The method of any of Aspect 1-Aspect 46, wherein at least 5% of the acetylene gas is converted.

Aspect 48. The method of any of Aspect 1-Aspect 46, wherein at least 30% of the acetylene gas is converted.

Aspect 49. The method of any of Aspect 1-Aspect 46, wherein at least 50% of the acetylene gas is converted.

Aspect 50. A composition comprising hydrogen and at least one solid carbon product, produced by the method of any one of Aspect 1-Aspect 49.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### J. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. CATALYST SYNTHESIS.

Monometallic and bimetallic catalyst containing (10 wt. % and 11 wt. % metals respectively) are dispersed on different support (CNT and Al₂O₃) and synthesized via solvothermal method. In monometallic catalyst, there was only one metal, Ni. The content of Ni was 10 wt. %. The rest of the catalyst was carbon nanotube (or Al₂O₃) support, which was 90 wt. %. In bimetallic catalyst, there were two metals, Ni and Pd. The content of Ni was 10 wt. %. The content of Pd was 1 wt. %. The rest of the catalyst was carbon nanotube (or Al₂O₃) support, which was 89 wt. %. Metal precursors nickel(II) nitrate hexahydrate (Ni(NO₃)₂·6H₂O) (Acros Organics, 99%, USA) and palladium(II) nitrate dihydrate (Pd(NO₃)₂·2H₂O) (Sigma-Aldrich, USA) are dispersed in 50 ml acetone under sonication for 2 minutes, then solution is continuously stirred for 20 minutes. CNT support (Cheap Tubes Inc. USA, diameter 20-30 nm) is added in the stirring metal precursor solution under stirring. The CNTs did come with metal residue, which was 1.5 wt. %. However, we have conducted reaction over only CNTs. The results showed no catalytic effect. It was our understanding that the metal residue was covered by carbon layer after production. Due to the sheath effect, the metal removal process they had during the production did not fully remove the metal, leaving a small amount of metal residue in this commercial CNT product. After 30 minutes, the resultant solution is transferred to Teflon lined stainless steel autoclave, sealed and heated to 130° C. for 12 hrs. The autoclave is cooled down to room temperature and liner is left in fume hood to evaporate acetone at room temperature overnight. The resultant sample is dried in oven at 80° C. for 12 hrs. Catalyst pre-treatment is carried out over the dried catalyst samples placed in tube furnace. Reduction is carried out in pure H₂ environment. Temperature is increased form the room temperature to 400° C. with a ramping rate of 10° C./min. Afterwards, the temperature is kept at 400° C. for 5 hours. Conventional heating in an electrical furnace was used to reduce the catalyst. The temperature was measured with a physical thermal couple sensor probe, which has been insert into catalyst bed during the reduction.

2. CATALYTIC DECOMPOSITION OF ACETYLENE USING MICROWAVE HEATING.

A variable frequency microwave reactor (Lambda Technology, USA) with working frequency 5.85 to 6.65 GHz and a solid-state microwave generator source was used to heat the catalyst bed, which was in a quartz tube. Temperature of the catalyst bed and quartz tube wall were monitored by two infrared pyrometers. The reaction temperature was controlled by a PID controlling software. For each test, 0.2 g (CNT support) and 0.5 g (Al₂O₃ support) catalyst was loaded into the reactor quartz tube reactor with 8 mm internal diameter. The composition of the outlet gas was analyzed by a two-column Micro Gas Chromatography (Micro-GC, Agilent Technologies). The flow rate of inlet gas was set initially at 40 mL/min with 2.5 mol % C₂H₄, 47.5 mol % Ar and 50 mol % N₂.

Nitrogen, as an inert and internal marker, was adopted for the conversion calculation purpose only at the lab scale. Thus, in these studies, a 40 ml/min overall flow rate was used, comprising 20 ml/min nitrogen internal standard as well as the acetylene model feed (5% acetylene and 95% Ar). The gas hourly space velocity (GHSV) of acetylene is 41.7 and 26.8 h−1 for CNT supported catalyst and Al₂O₃ supported catalyst, respectively.

3. CATALYTIC DECOMPOSITION OF ACETYLENE USING THERMAL HEATING.

The reaction was carried out in a fixed-bed quartz tube reactor with an internal diameter of 8 mm. The reactor was heated by an electric tubular furnace (Applied Test System Inc, USA). Reaction temperature was measured by a K-type thermocouple placed at the top of catalyst bed. The flow rate of inlet gas was set initially at 40 mL/min with 2.5 mol % C₂H₄, 47.5 mol % Ar and 50 mol % N₂. Before reaction, the reactor was purged with nitrogen at a flow rate of 40 mL/min. Then, it was ramped to 400° C. at ramping rate of 10° C./min. TGA of pure CNT was carried out to mark a reference for the oxidation temperature of the produced samples.

4. PRODUCT ANALYSIS.

The acetylene pyrolysis reaction was carried out over the pre-reduced catalyst 10Ni-1Pd-CNT (at 500° C.), 10Ni—Al₂O₃ (at 400° C.), and 10Ni-1Pd-Al₂O₃ (at 400° C.) under microwave heating inside a quartz tube reactor. 0.2 g (10Ni-CNT and 10Ni-1Pd-CNT) and 0.5 g (10Ni—Al₂O₃ and 10Ni-1Pd-Al₂O₃) catalyst was placed between quartz wool in the center of reactor under the inflow of gaseous reactant with an inlet molar composition as mentioned above with N₂ as internal marker. Under reaction conditions, the C₂H₂ conversion (%) was described as follows in eq. (1).

C₂H₂ conversion (%)=(1−(C₂H₂^{out} N₂ⁱⁿ/C₂H₂ⁱⁿN₂^{out}))×100% (Eq.1)

In Eq. 1, it should be noted that C₂H₂^{out} and C₂H₂ⁱⁿ were the mole concentrations of the C₂H₂ at outlet and inlet, respectively, and N₂^{out} and N₂ⁱⁿ were the mole concentration of the N₂ outlet and inlet, respectively.

5. CATALYST CHARACTERIZATION.

Thermal gravimetric analysis (TGA) and differential thermogravimetry (DTG) analysis are performed using STD-Q650 instrument (TA instruments, USA), wherein sample is heated at 10° C./min from 30° C. to 400° C. and 2° C./min form 400° C. to 700° C., respectively, under the flow of air. The morphology of the catalysts and produced carbon nanomaterials was analyzed with a transmission electron microscope (TEM). The TEM images were obtained with a JEOL JEM-2100 operated at an accelerating voltage of 200 kV. Raman spectroscopic analysis was performed using a Renishaw InVia Raman microscope with an excitation wavelength of 532 nm.

6. PERFORMANCE OF NI-PD-CNT CATALYST IN C₂H₂ CATALYTIC DECOMPOSITION.

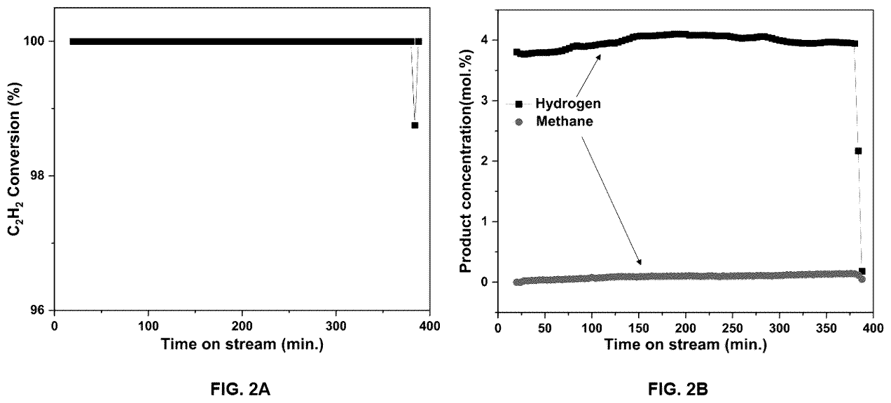

Data obtained for catalytic performance of 10Ni-1Pd-CNT catalyst at 500° C. showed that the acetylene can be converted to carbon and hydrogen (see FIGS. 2A-2B). The dominant gas product was hydrogen with 4.2 mol % concentration at 150-minute time on stream (TOS) and 100% C₂H₂ conversion through the catalyst lifetime. Minor products observed were methane, ethane, ethylene, and acetylene. However, these by-products had extremely low concentrations (generally less than 0.05 mol %).

7. PERFORMANCE OF AL₂O₃ SUPPORTED NI FOR C₂H₂ CATALYTIC DECOMPOSITION.

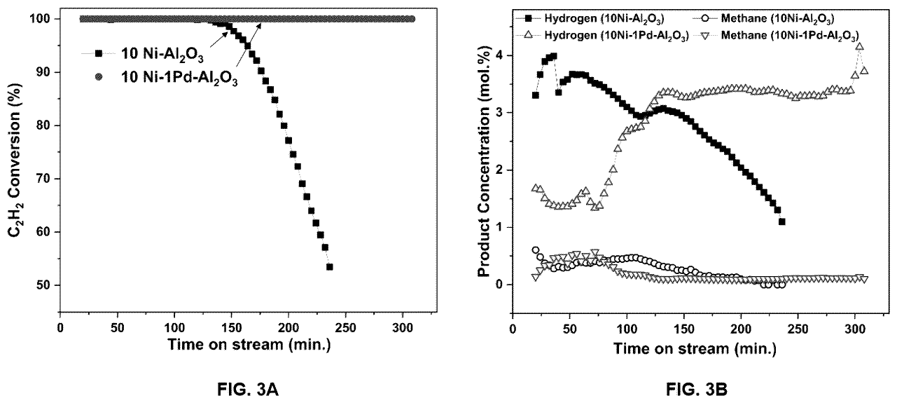

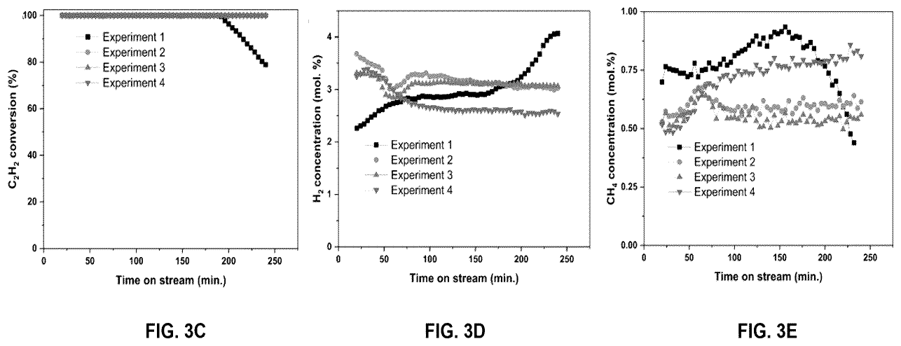

Further studies demonstrated that at 400° C. acetylene can be dehydrogenated with hydrogen as dominant gas with 2.9 mol % and 3.2 mol % concentration with 100% C₂H₂ conversion in product stream at 150-minute TOS for 10Ni—Al₂O₃ and 10Ni-1Pd-Al₂O₃ catalyst, respectively (see FIGS. 3A-3B). Without wishing to be bound by a particular theory, it is believed that the drop in conversion for 10Ni—Al₂O₃ catalyst could be due to pressure build up in the reactor tube after 150-minute TOS. Further experiments, e.g., characterization using Raman spectroscopy and TEM, were carried out to further assess the carbon deposited over the catalyst during acetylene pyrolysis (as described following below).

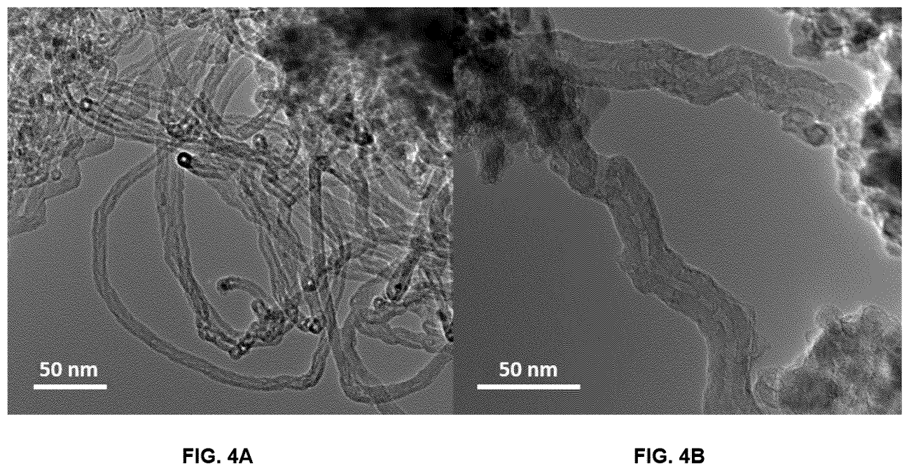

FIGS. 4A-4B show TEM images that provide information regarding the morphology, particle size, diameter, and growth of CNT over spent 10Ni—Al₂O₃ and 10Ni-1Pd-Al₂O₃ catalyst. Carbon deposited over the catalyst appeared to be multiwalled CNT which appears to have hollow cylindrical shape. FIGS. 4A-4B show CNT growth over the Ni particle over 10Ni—Al₂O₃ catalyst. The average diameter of CNT generated observed was 12 nm and 22 nm over 10Ni—Al₂O₃ and 10Ni-1Pd-Al₂O₃ catalyst, respectively. In separate experiments, it was determined that the average diameter of CNT generated observed was 12.3 nm and 17.8 nm over 10Ni—Al₂O₃ and 10Ni-1Pd-Al₂O₃ catalyst, respectively. Similar narrow diameter CNTs were synthesized with an average size of 50 nm over 40 wt % loading of Ni on Al₂O₃ in a previous report (Ref. 33). In that same report, it was observed that when the Ni loading was replaced with 20 wt. % Ni and 20 wt. % Fe, a smaller size of CNT was obtained. However, it was widely accepted that the size of the CNT product from acetylene decompositions reactions was likely influenced more by the size of the active metal particles. In addition, the carbon yield was significantly increased when Ni—Fe system was adopted as compared to Ni only catalyst. The growth of CNT from acetylene decomposition was typically tip-growth (Ref. 34).

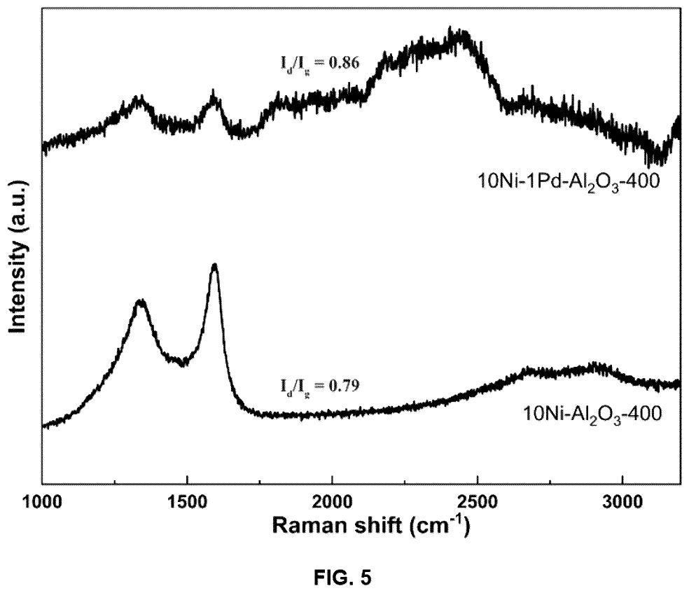

To further assess the nature and quantity of deposited carbon over the catalyst, Raman spectroscopy was carried over the spent catalyst. Raman spectra of spent 10Ni—Al₂O₃ and 10 Ni-1Pd-Al₂O₃ catalyst is shown in FIG. 5. Two characteristic peaks, D-band (1350 cm-1) and G-band (1570 cm⁻¹), are observed in the form of Raman scattering for 10 Ni—Al₂O₃ spent catalyst-which suggests the presence of CNT over the catalyst. The D-band likely represents either disordered or amorphous carbon, whereas the G-band likely represents crystalline carbon. The intensity ratio I_{D}/I_{G} can be used to explain the graphitization degree and the crystallinity of the CNTs. The carbon with the lowest I_{D}/I_{G} value is having the highest crystallinity. A 0.79 I_{D}/I_{G} ratio was observed for 10Ni—Al₂O₃, thereby suggesting high crystalline carbon was deposited over the catalyst.

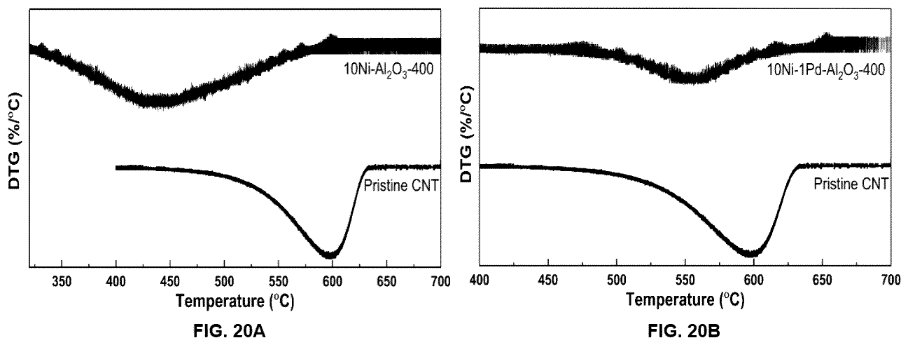

The crystallinity of produced CNT was examined by using TGA analysis. FIGS. 20A-20B show the oxidation temperature peak for the spent 10Ni—Al₂O₃ and 10Ni-1Pd-Al₂O₃ catalyst. There is no observation of thermal degradation in the temperature range of 200˜350° C., which corresponds to amorphous carbon, and accordingly, confirms that no amorphous is deposited over the spent catalyst.

8. PERFORMANCE OF CNT SUPPORTED CATALYST FOR USE IN C₂H₂ PYROLYSIS.

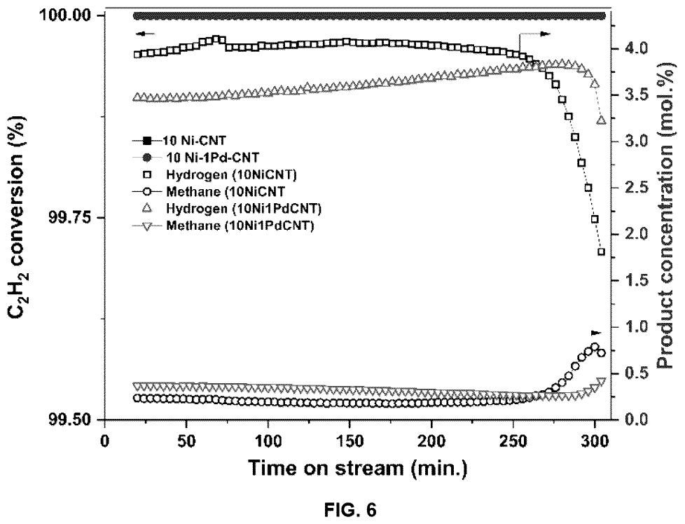

Catalytic performance of the 10Ni-CNT and 10Ni-1Pd-CNT catalyst is shown in FIG. 6. As shown in this figure, the catalyst maintained stable activity over a period of 4 hours. Without wishing to be bound by a particular theory, it is believed that this may be attributable to a low concentration of reactive gas in the inlet stream. With addition of Pd (1 wt %), C₂H₂ conversion remained constant at 100%, whereas the H₂ concentration increased form 3.47 mol % at 60 min to 3.87 mol % after 240 min. TOS (FIG. 6). Based on these product concentration data, it appears that addition of Pd in catalyst may retard catalyst deactivation. In a prior study, it was reported that formation of Ni—Pd alloy can be associated with increased catalyst stability (Ref. 10).

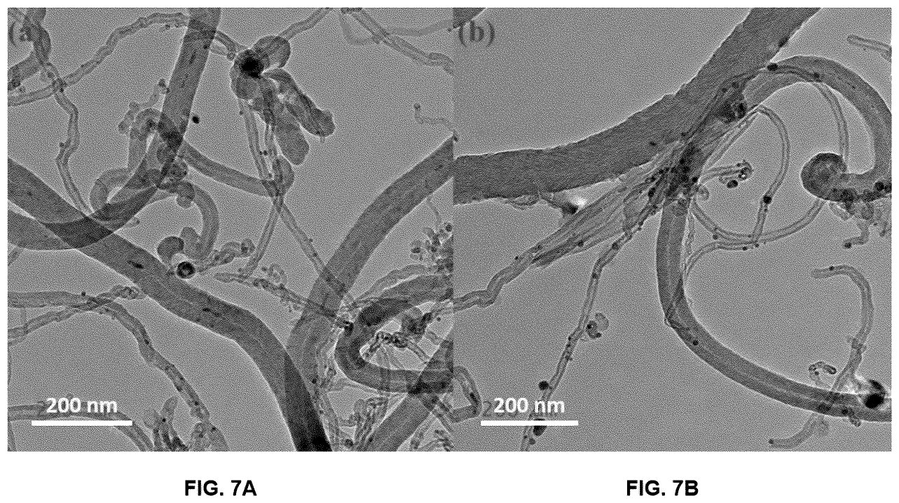

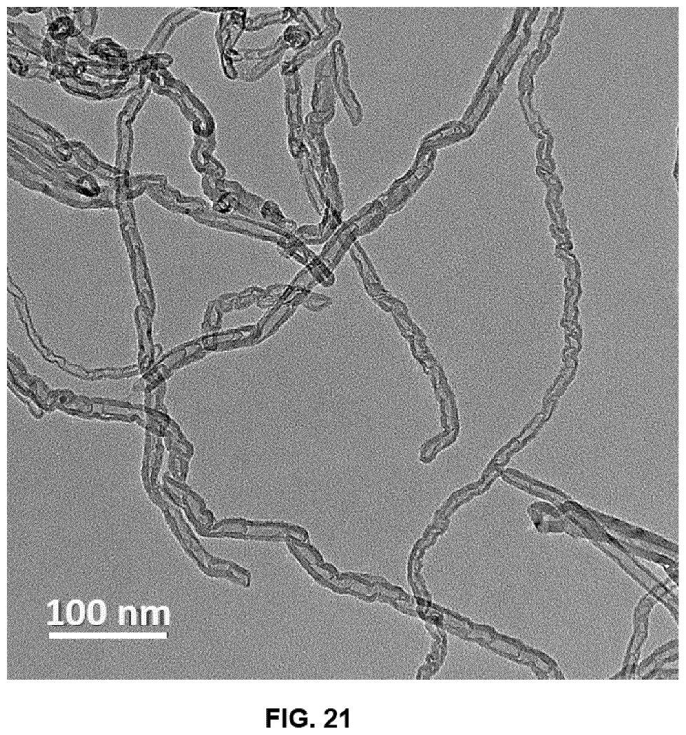

In order to assess the morphology of the CNT used as support and the CNT deposited over the catalyst during pyrolysis, TEM images were obtained of the CNT support is shown in FIG. 21. The image data indicate that a typical diameter of the CNT support was 20 nm. Carbon deposited over the catalyst appeared to be carbon nano fibers with a hollow cylindrical shape. FIGS. 7A-7B show CNT growth over 10Ni-CNT catalyst with Ni metal entrapped inside the CNT. The average diameter CNT observed was 53 nm and 56 nm over 10Ni-CNT and 10Ni-1Pd-CNT catalyst, respectively. The thinner CNT in FIGS. 7A-7B is believed to be the original CNT support (˜20 nm).

In separate experiments, carbon nanotube growth was determined over a 10Ni-CNT catalyst with Ni metal entrapped inside the carbon nanotube. In this separate experiment, the average diameter CNT generated is 49.4 nm and 53.9 nm over 10Ni-CNT and 10Ni-1Pd-CNT catalyst respectively.

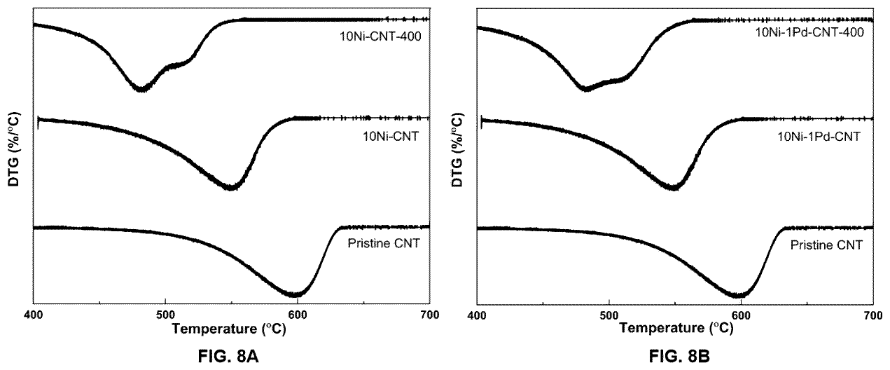

CNT produced during the reaction was examined using TGA analysis. FIGS. 8A-8B show the oxidation temperature peak for the spent 10Ni-CNT and 10Ni-1Pd-CNT catalyst. It was observed that no thermal degradation appeared to occur in the temperature range of 200-350° C., which corresponds to amorphous carbon, and thereby confirms that there is no apparent amorphous deposited over the spent catalyst. The oxidation temperature of CNT support spent catalyst was observed at a temperature higher than 450° C., suggesting that carbon produced on the spent catalyst during the course of the reaction was crystalline in nature.

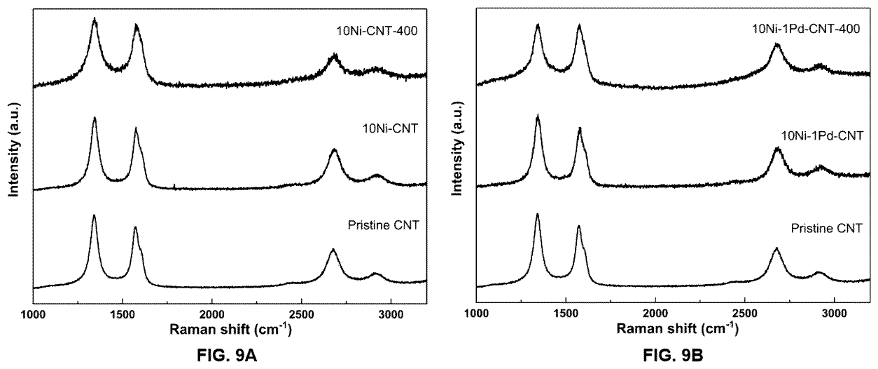

To further assess the degree of crystallinity Raman spectroscopy was performed over the catalyst. FIGS. 9A-9B show the Raman spectra of pure CNT, reduced catalyst and spent catalyst. Two distinct bands at 1350 cm⁻¹ and 1571 cm⁻¹ were observed. The I_{d}/I_{g} ratio of pure CNT is 1.19. When comparing the change in I_{d}/I_{g} ratio between the reduced and spent catalyst no significant change was observed. For 10Ni-CNT, the I_{d}/I_{g} ratio changed from 1.21 to 1.08 between freshly reduced and spent catalysts, whereas for 10Ni-1Pd-CNT, the I_{d}/I_{g} ratio it changed from 1.02 to 0.90. Based on these data, it can be concluded that there is change in crystallinity of the catalyst after 5 hrs. of reaction under C₂H₂ flow.

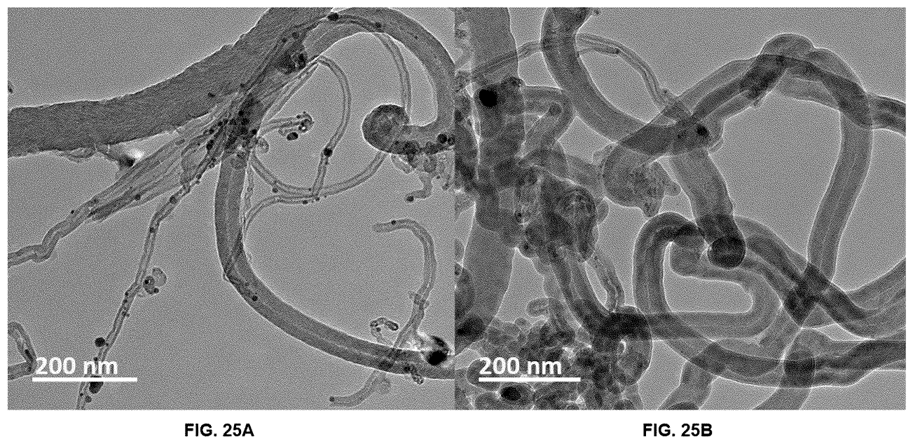

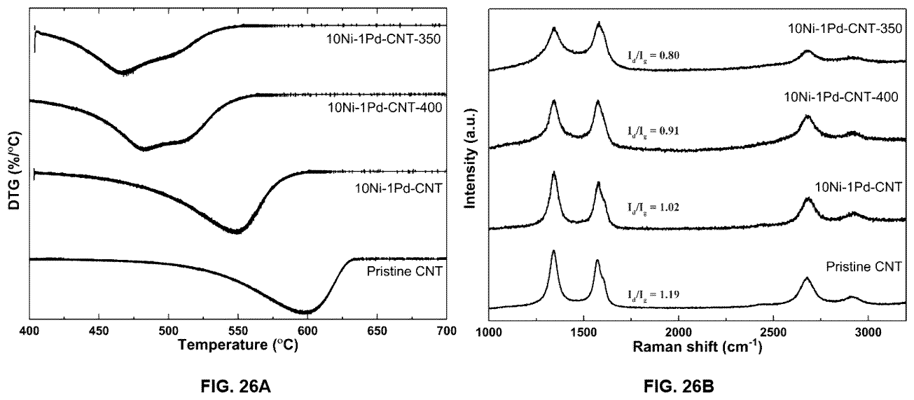

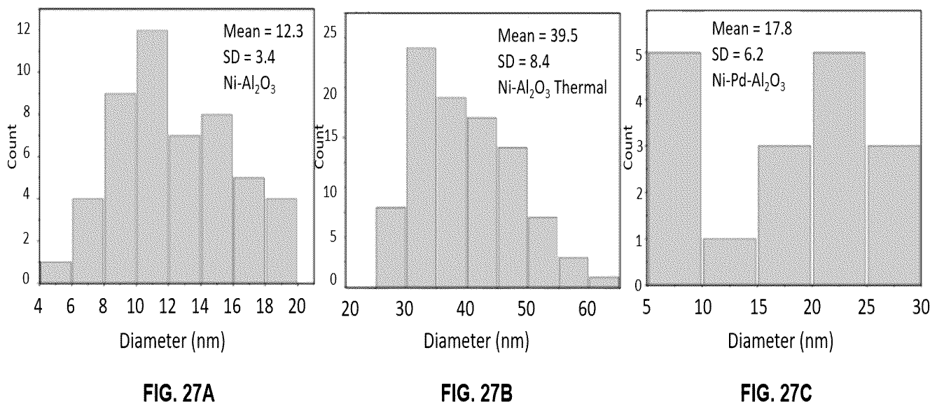

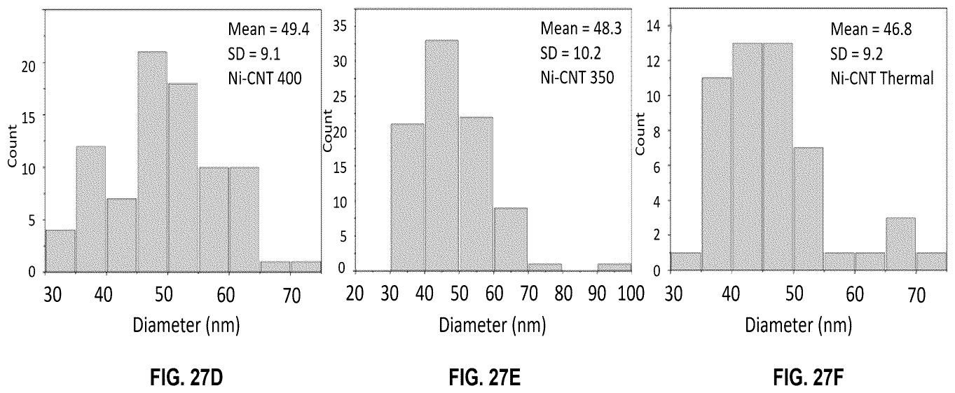

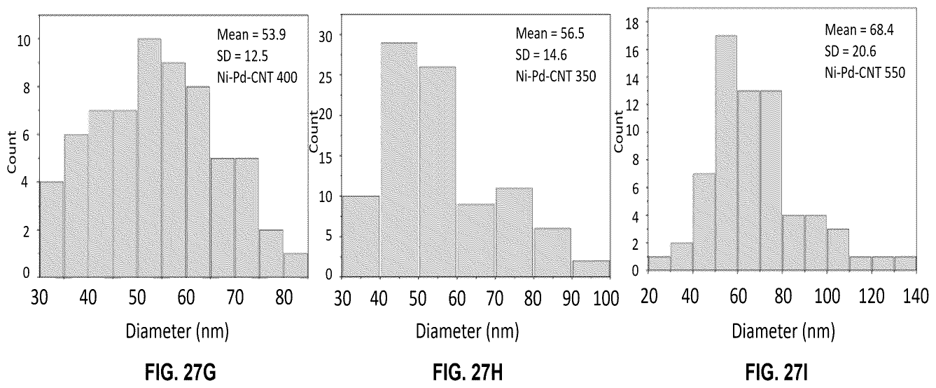

Carbon nanomaterial size distribution of spent catalyst is shown in FIGS. 27A-27I.

9. EFFECT OF HEATING SOURCE ON CATALYST PERFORMANCE.

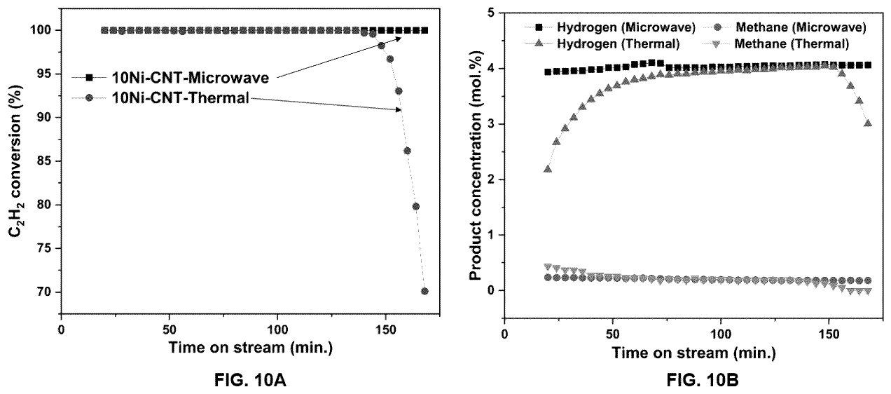

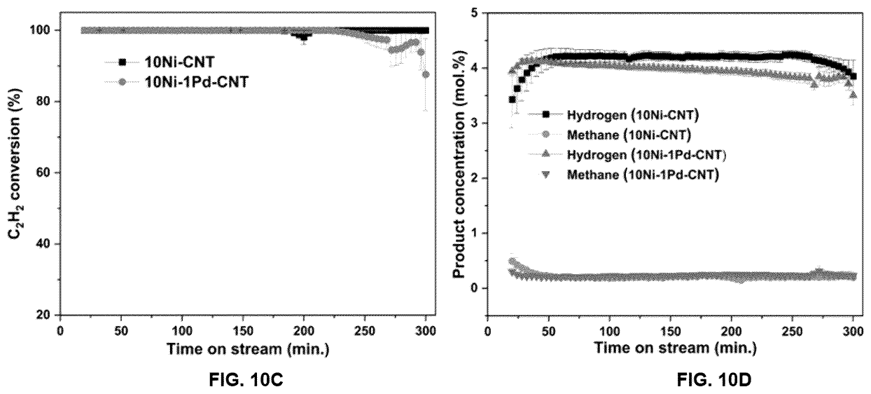

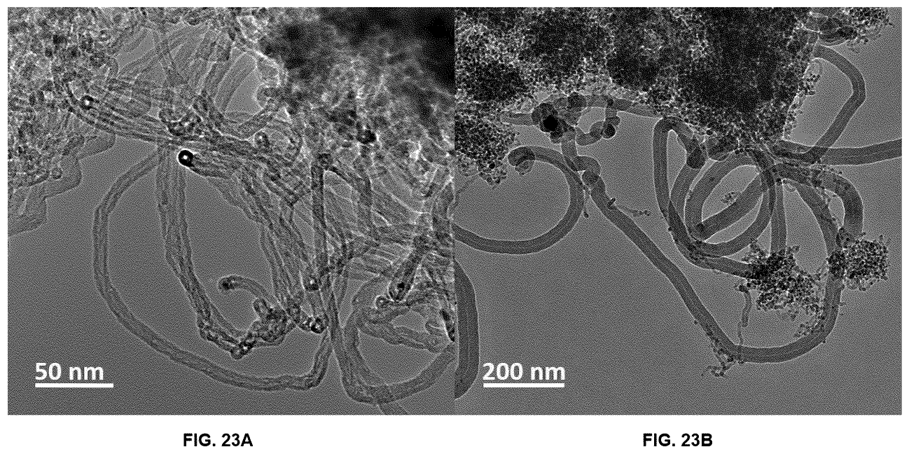

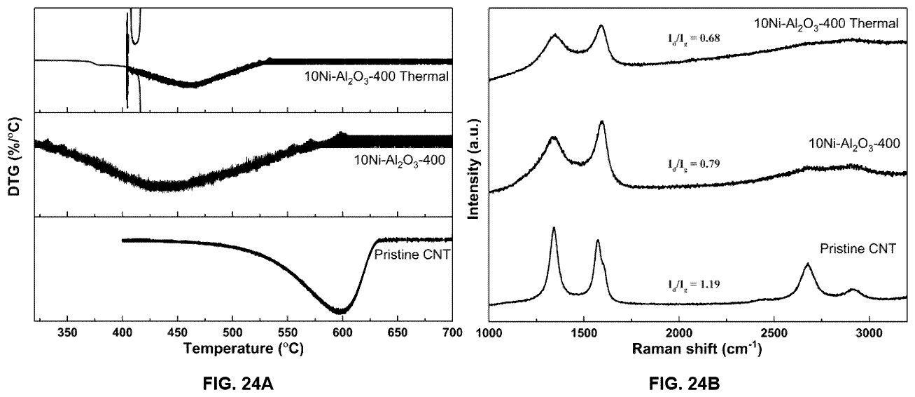

Catalytic performance of 10Ni-CNT catalyst under microwave and thermal heating is carried out and FIGS. 10A-10B show the activity data. From FIG. 10A we observe that acetylene conversion is constant at 100% for 130-minute TOS for thermally heated catalyst and then conversion decreases whereas, for microwave heating the conversion is constant at 100%. The decrease in the conversion is attributed to pressure build-up in the reactor tube. FIG. 10B shows the product concentration profile for 10Ni-CNT catalyst. It is observed that at the beginning of the reaction, the dominant gas product is hydrogen with 4 mol % for microwave heating. For thermal heating, the initial concentration is 2.5 mol % and it increases to 3.9 mol % at 120 min. The concentration of methane is constant at 0.4 mol % and 0.7 mol % for microwave and thermal heated reactions, respectively. The CNT could absorb microwave effectively duo to that delocalized Π electrons of sp2-hybridized atomic network (Ref. 35). Microwave was reported to heat CNT via two main mechanisms: dipolar polarization and conduction (Ref. 36). Further data are shown in FIGS. 24A-24B.

FIGS. 10C-10D show additional experiments for the catalytic performance of the 10Ni-CNT and 10Ni-1Pd-CNT catalyst. As shown in the figure, the catalyst maintained stable activity within 4 hours. This may be attributed to the low concentration of reactive gas in the inlet stream. With addition of Pd (1 wt. %), C₂H₂ conversion remains constant at 100%, whereas the H₂ concentration increases form 3.47 mol % at 60 min to 3.87 mol % after 240 min. TOS (FIGS. 10C-10D). Based on product concentration data it is—without wishing to be bound by a particular theory—that addition of Pd in catalyst can retard catalyst deactivation.

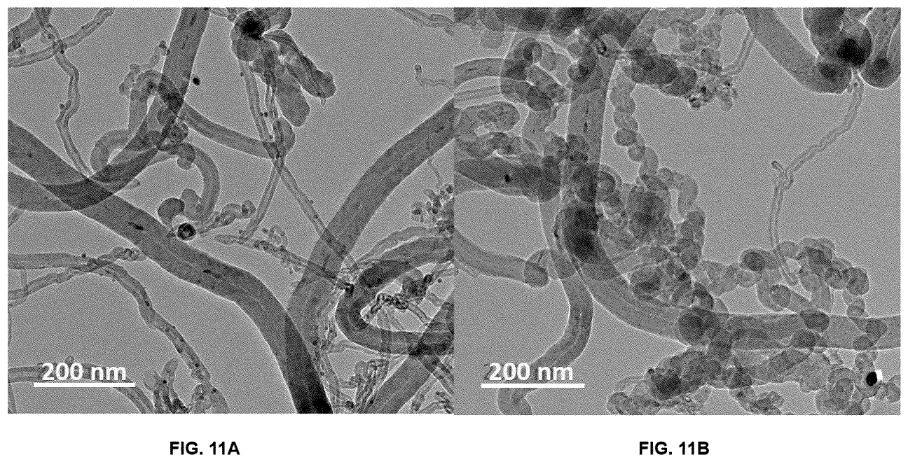

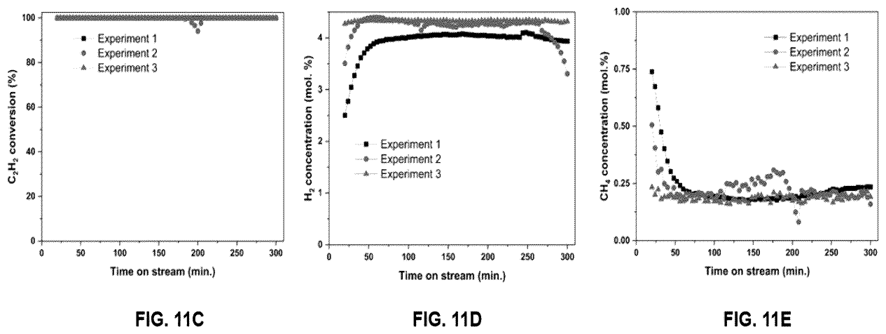

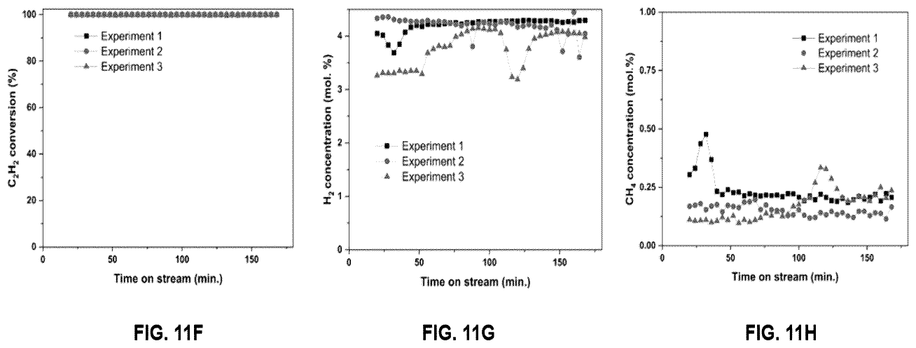

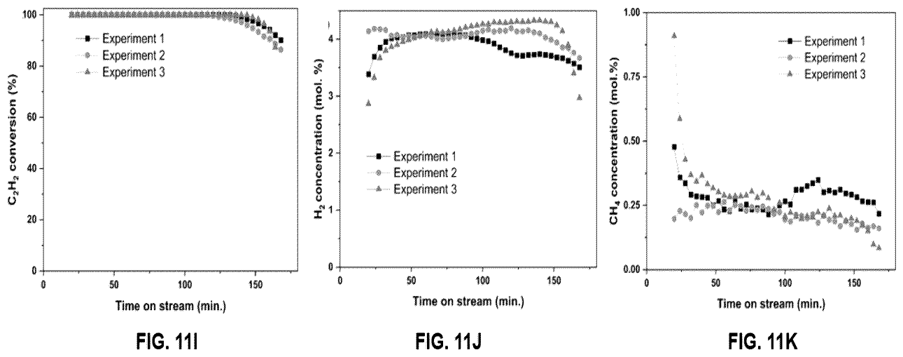

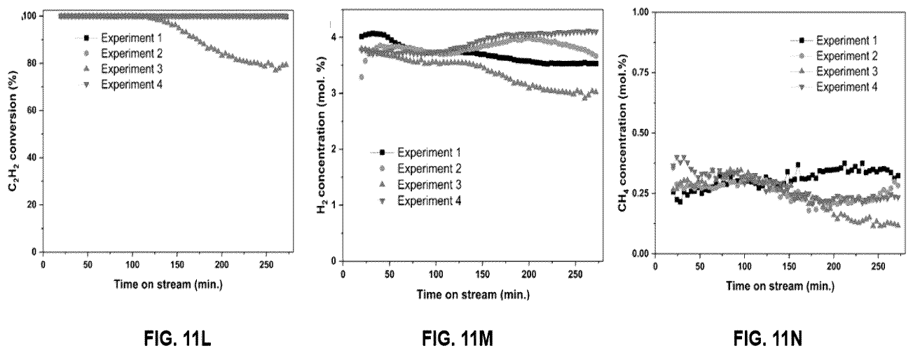

FIGS. 11A-11B show CNT growth over 10Ni-CNT catalyst with Ni metal entrapped inside the CNT. The average diameter CNT observed was 53 nm and 63 nm over (FIG. 11A) microwave and (FIG. 11B) thermal heated spent 10Ni-CNT catalyst, respectively. Spiral CNT was observed for thermal heated catalyst.

In separate experiments, carbon nanotube growth was determined over a 10Ni-CNT catalyst with Ni metal entrapped inside the CNT. The average diameter CNT generated was 49.4 nm and 46.8 nm over, respectively, microwave and thermal heated spent 10Ni-CNT catalyst.

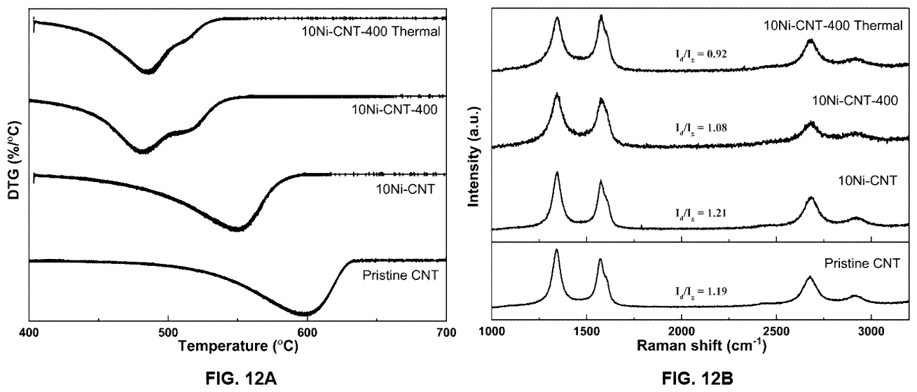

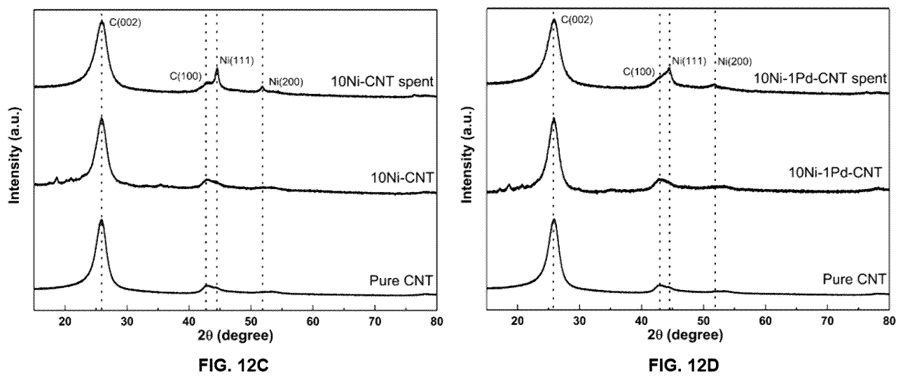

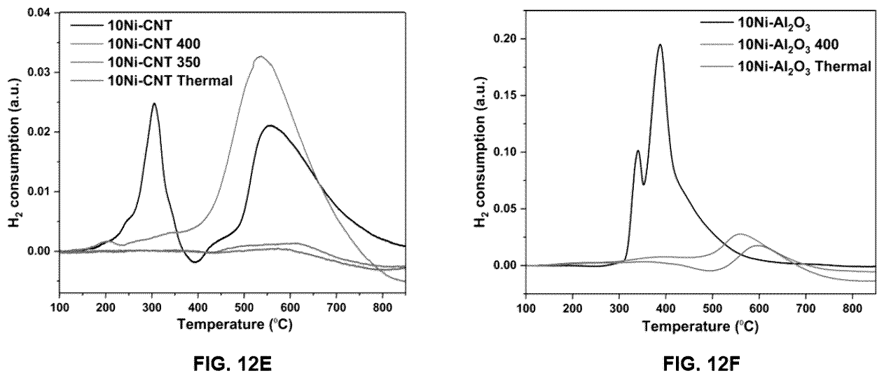

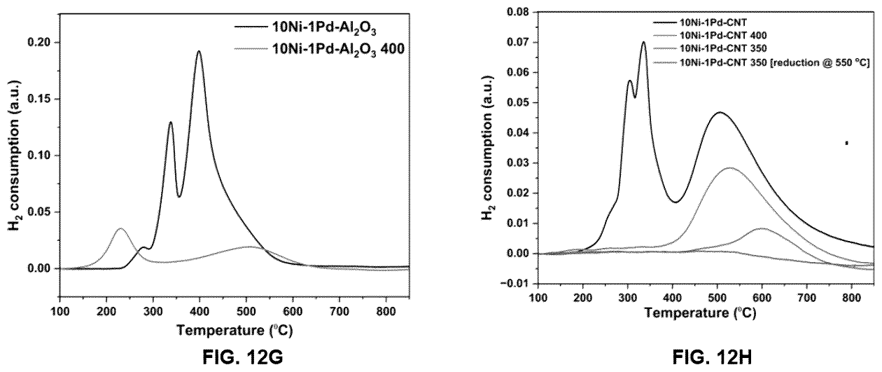

Reduced and spent catalysts were examined using TGA and Raman spectroscopy to assess thermal stability and crystallinity (FIGS. 12A-12B). The TGA data show that the catalyst had a high degree of crystallinity since as no weight loss was observed below 400° C. (see FIG. 12A). The data collected using Raman spectroscopy (see FIG. 12B) show that there was no significant change in the I_{d}/I_{g} ratio between the reduced and spent catalysts. In the microwave-heated reaction, it was observed that the I_{d}/I_{g} ratio changed from 1.21 to 1.08 between fresh and spent catalyst, whereas in the thermal heated reaction, the I_{d}/I_{g} ratio decreased to 0.92. In view of these data, it can be concluded that there was no abrupt change in crystallinity of the catalyst after 150 min under C₂H₂ flow. X-ray diffraction (XRD) analysis was performed over the catalyst. The XRD pattern of the pure CNT, 10Ni-CNT, 10-Ni-1 Pd-CNT, 10Ni-CNT spent, and 10-Ni-1Pd-CNT spent catalyst shows their characteristic peak confirming the crystalline structure as shown in FIGS. 12C-12D. The absence of broad reflection for C (002) at 25.9 degree in the spent 10 Ni-CNT (FIG. 12C) and 10Ni-1Pd-CNT (FIG. 12D) confirms the deposited carbon on the catalyst during activity test is not amorphous in nature (Refs. 36-37). The XRD spectra of 10Ni-1Pd-CNT shows similar pattern with that of 10Ni-CNT confirms formation of Ni based Ni—Pd alloy lattice (Ref. 38). Temperature programmed reductions with hydrogen (TPR-H₂) were carried out for as synthesized catalyst precursors and spent catalysts. The results were included in supporting information as FIGS. 12E-. The results showed that NiO peak between 300-400° C. disappeared after the run [41]. The TPR peaks between 550-650° C. over the spent catalyst was attributed to the reduction of carbon [42]. The peak increase of 550° C. in alumina support was due to the production of CNT during the reaction, which was reduced by hydrogen later in the TPR test.

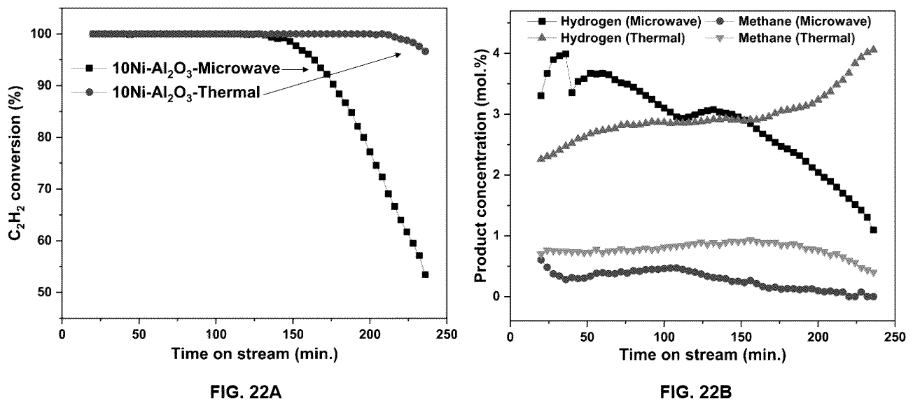

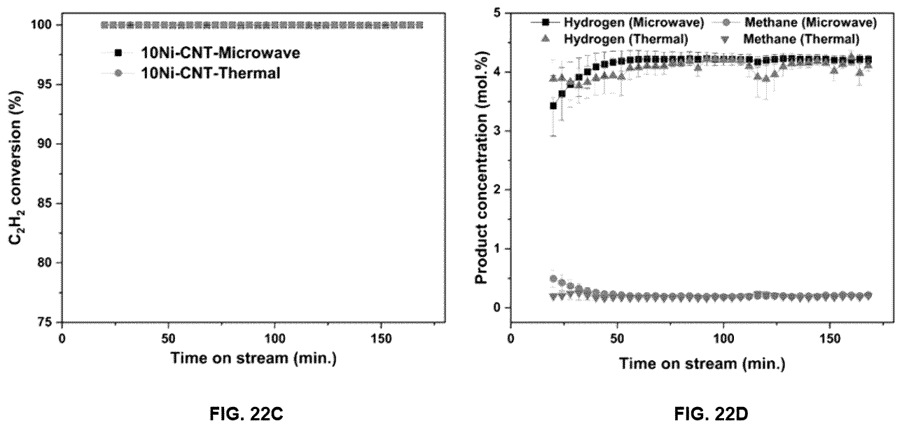

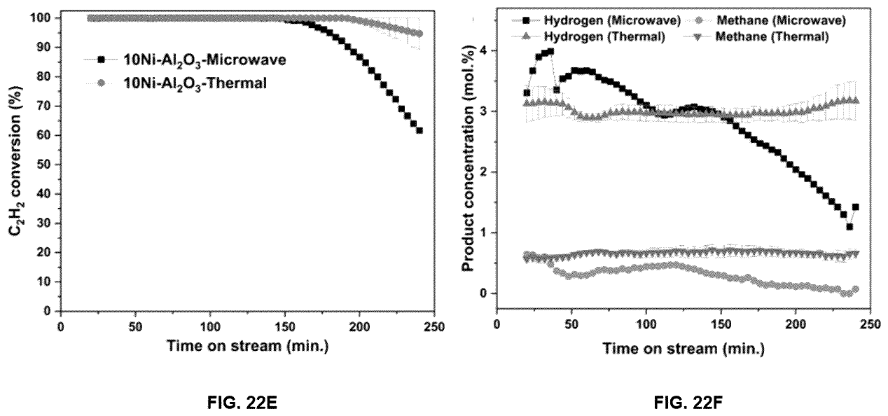

Catalytic performance of a disclosed 10Ni—Al₂O₃ catalyst when heated with either microwave or thermal heating was assessed, and the data are shown in FIGS. 22A-22B. From FIG. 22A, it can be seen that acetylene conversion was constant at around 100% for 130-minute TOS for microwave heated catalyst and then conversion decreased whereas, for thermal heating the conversion was constant at 100%. The data FIG. 22B show a representative product concentration profile for a disclosed 10Ni—Al₂O₃ catalyst. The data show that at initial TOS, the dominant gas product was hydrogen with 4 mol % for microwave heating, whereas for thermal heating, the initial hydrogen concentration was 2.5 mol % which increased to 3.5 mol % at 200 min. TOS. The concentration of methane was constant @ 0.4 mol % and 0.7 mol % for microwave and thermal catalyst heating, respectively. See also additional data at FIGS. 22E-22F.

Catalytic performance of 10Ni-CNT catalyst under microwave and thermal heating was carried out and the activity data are shown in FIGS. 22C-22D. The data show that acetylene conversion is constant at 100% for 130-minute TOS for thermally heated catalyst and then conversion decreases whereas for microwave heating the conversion was constant at 100%. The decrease in the conversion is attributed to pressure build-up in the reactor tube. FIG. 22D shows the product concentration profile for 10Ni-CNT catalyst and the data show that at the beginning of the reaction, the dominant gas product was hydrogen with 4 mol % for microwave heating. For thermal heating, the initial concentration was 2.5 mol % and it increased to 3.9 mol % at 120 min. The concentration of methane was constant at 0.4 mol % and 0.7 mol % for microwave and thermal heated reactions, respectively.

FIGS. 23A-23B show CNF growth over a disclosed 10Ni—Al₂O₃ catalyst having Ni metal entrapped inside the CNF. The average diameter CNF generated was 12 nm and 38 nm over (FIG. 23A) microwave and (FIG. 23B) thermal heated spent 10 Ni— Al₂O₃ catalyst, respectively.

10. EFFECT OF REACTION TEMPERATURE ON CATALYST PERFORMANCE.

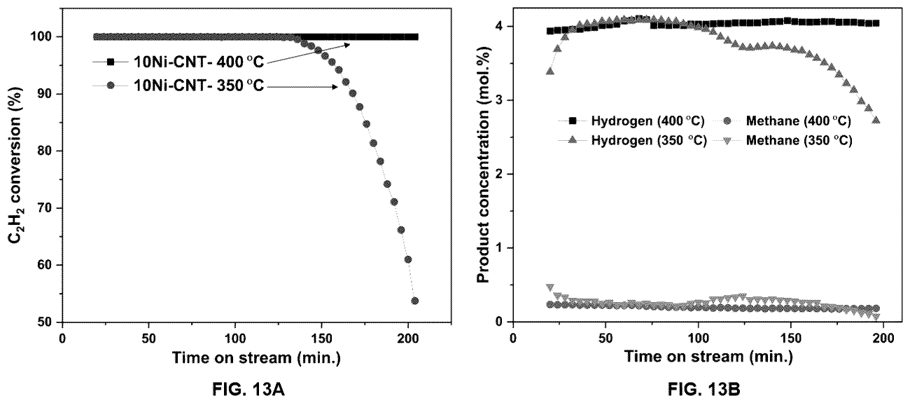

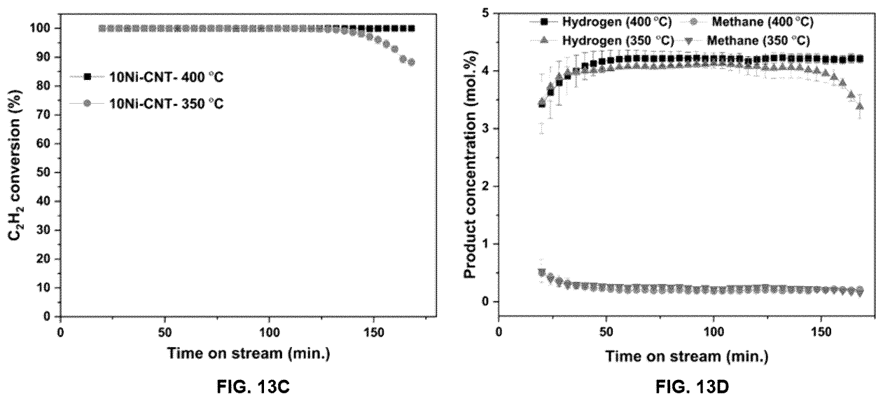

Catalytic performance of 10Ni-CNT catalyst at two different temperatures (400° C. and 350° C.) under microwave was carried out and representative data are showin in FIGS. 13A-13B. From FIG. 13A, it can be observed that acetylene conversion was constant at 100% for 200-minute when catalytic reaction was carried out at 400° C. (catalyst temperature), whereas when the reaction was carried out at 350° C. (catalyst temperature) under microwave heating, conversion was constant at 100% up to 130 min. and then decreased to 50% at 200 min. Without wishing to be bound by a particular theory, it is believed that the decrease in the conversion could be attributable to pressure build-up in the reactor tube. FIG. 13B shows data for a representative product concentration profile obtained from reaction using a 10Ni-CNT catalyst. The data show that at the beginning of the reaction, the dominant gas product was hydrogen with 4 mol % for reaction carried out at catalyst temperature of 400° C. When the reaction was carried out at 350° C. (catalyst temperature), the initial concentration was 3.5 mol % and it increased to 4 mol % at 60 min. With increase in reaction time, H₂ mole concentration decreased to 2.7%. Without wishing to be bound by a particular theory, it is believed this decrease in H₂ is associated with low C₂H₂ conversion. It should be noted that the reaction temperature in the methods disclosed herein is much lower than the conventional approaches which are typically carried out at high thermal heating temperatures (>500° C.). Accordingly, it is believed that the disclosed methods provide a significant advantage over conventional methods in terms of reduced overall energy consumption. Further data are shown in FIGS. 13C-13D.

FIGS. 14A-14B show CNT growth over a disclosed 10Ni-CNT catalyst with Ni metal entrapped inside the CNT. The average diameter CNT generated was 53 nm and 41 nm over spent 10Ni-CNT catalyst, respectively, for reaction carried out at 400° C. and 350° C. under microwave heating.

In separate experiments, carbon nanotube growth was determined over a 10Ni-CNT catalyst with Ni metal entrapped inside the CNT. The average diameter CNT generated was 49.4 nm and 48.3 nm over spent 10Ni-CNT catalyst, respectively, for reaction done at 400° C. and 350° C. under microwave heating.

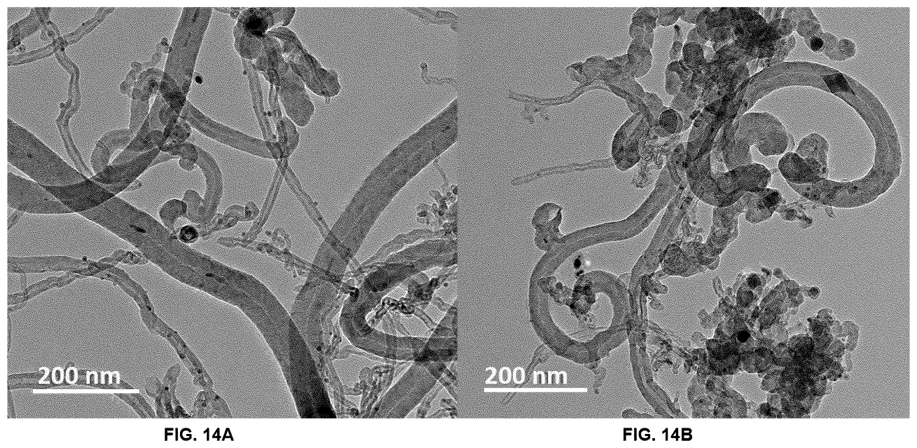

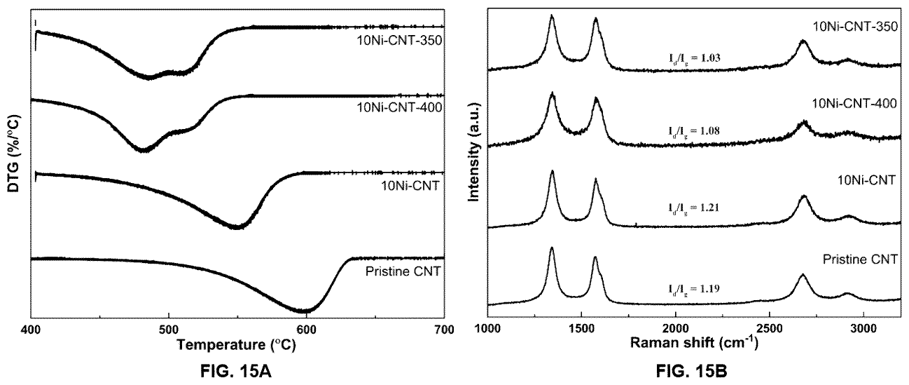

CNT produced in the reaction was examined using TGA analysis. FIG. 15A shows the oxidation temperature peak for the spent disclosed 10Ni-CNT catalyst. The data show that no thermal degradation was observed in the temperature range of 200-350° C., which corresponds to amorphous carbon and confirms that no amorphous was deposited over the spent catalyst. The observed oxidation temperature of CNT support spent catalyst was greater than 450° C., suggesting that carbon products from the reaction on the spent catalyst are crystalline in nature. To further verify the degree of crystallinity, Raman spectroscopy was carried out over the catalyst and the data are shown in FIG. 15B. The data show that for microwave heated catalyst at 400° C., the I_{d}/I_{g} ratio changed from 1.21 to 1.08 comparing reduced to spent samples, whereas when the catalyst was heated at 350° C., the I_{d}/I_{g} ratio changed to 1.03. From these data, it can be concluded that there was no abrupt change in crystallinity of the catalyst after 200 min under C₂H₂ flow.

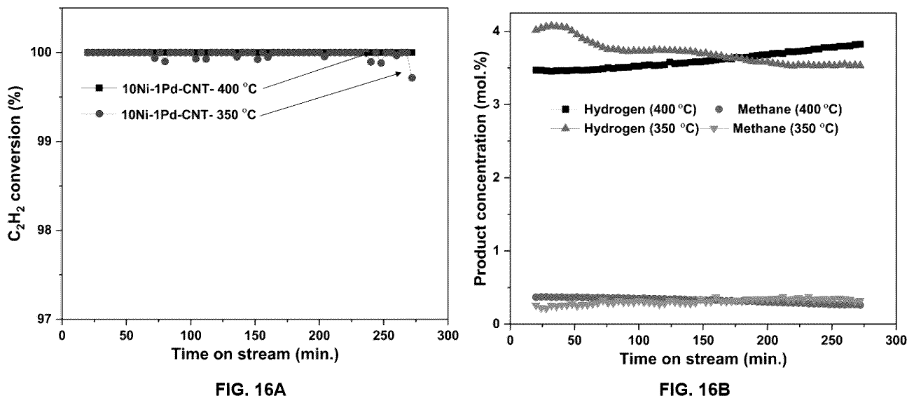

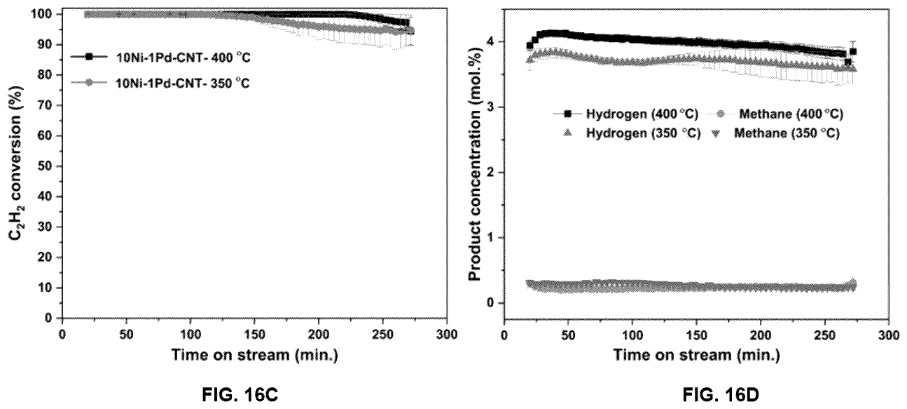

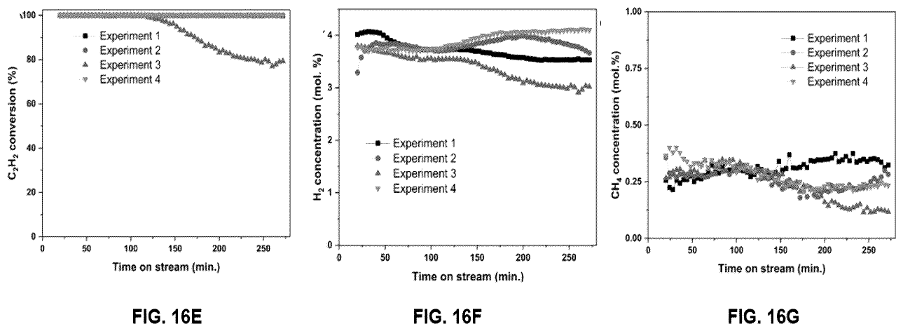

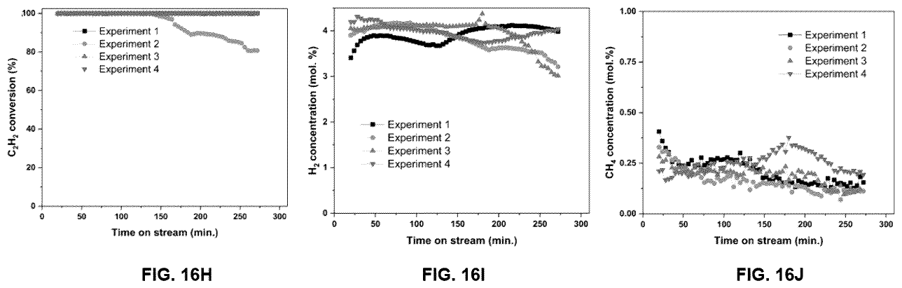

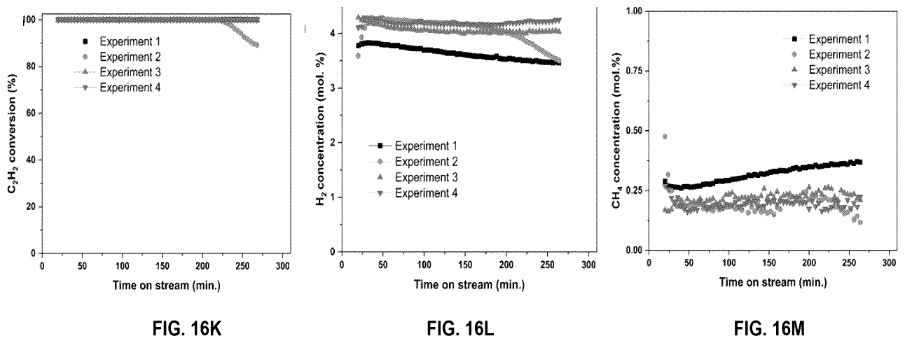

Catalytic performance of 10Ni-1 Pd-CNT catalyst was characterized at two different temperatures (400° C. and 350° C.) under microwave heating. From FIG. 16A, it can be seen that acetylene conversion was constant at 100% for 270-minute when the catalytic reaction was carried out at both 400° C. and 350° C. catalyst temperature. FIG. 16B shows a representative product concentration profile for a disclosed 10Ni-1Pd-CNT catalyst. The data show that during C₂H₂ pyrolysis, the dominant gas product was hydrogen with initial concentration of 3.5 mol % when the catalyst was heated to 400° C., and it increased to 4 mol % at 270 min. When the reaction was carried out at 350° C., the initial hydrogen concentration was 4 mol %, and it decreased to 3.5 mol % at 270 min. Further data are shown in FIGS. 16C-16D.

To further verify the characteristics like morphology, strength, and crystallinity of the produced CNT during the reaction, TEM, TGA and Raman analysis are carried out over the spent catalysts and the results are shown in FIGS. 25A-25B and FIGS. 26A-26B. Briefly, FIGS. 25A-25B show TEM images demonstrating CNF growth over 10Ni-CNT catalyst with Ni metal entrapped inside the CNF. The average diameter CNF generated was 56 nm and 41 nm over spent 10Ni-CNT catalyst, respectively, for reaction carried at 400° C. and 350° C. under microwave heating.

CNF produced in the reaction was characterized using TGA analysis. FIG. 26A shows an oxidation temperature peak for the spent 10Ni-1Pd-CNT catalyst. The data show that no thermal degradation was observed in the temperature range of 200-350° C., suggesting that no amorphous carbon was deposited over the spent catalyst. The observed oxidation temperature of CNT support spent catalyst was higher than 450° C., suggesting that carbon produced in the reaction and forming on the spent catalyst was crystalline in nature. To further verify the degree of crystallinity Raman spectroscopy was carried out over the catalyst and the data are shown in FIG. 26B. When the catalyst was heated at 400° C. using microwave irradiation, the I_{d}/I_{g} ratio changed from 1.02 to 0.91 comparing reduced to spent samples. The I_{d}/I_{g} ratio for catalyst heated at 350° C. with microwave irradiation changed to 0.8. In view of these data, it can be concluded that incorporation of Pd in the catalyst system provides in the reaction a more ordered graphitic carbon that is deposited during C₂H₂ pyrolysis.

11. EFFECT OF REDUCTION TEMPERATURE ON CATALYST PERFORMANCE.

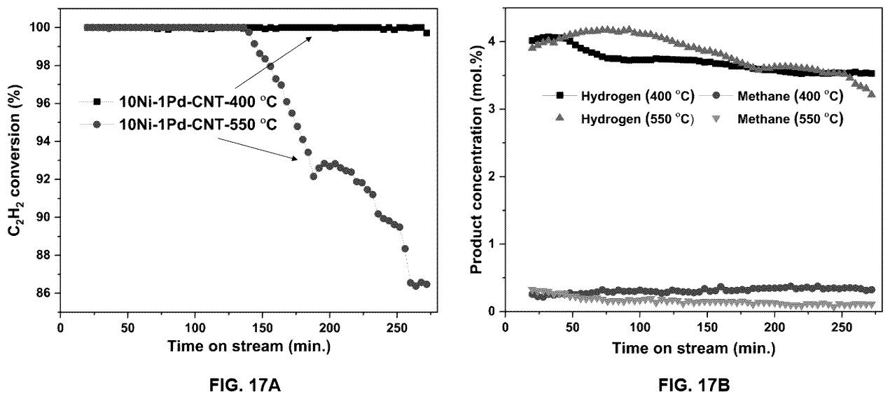

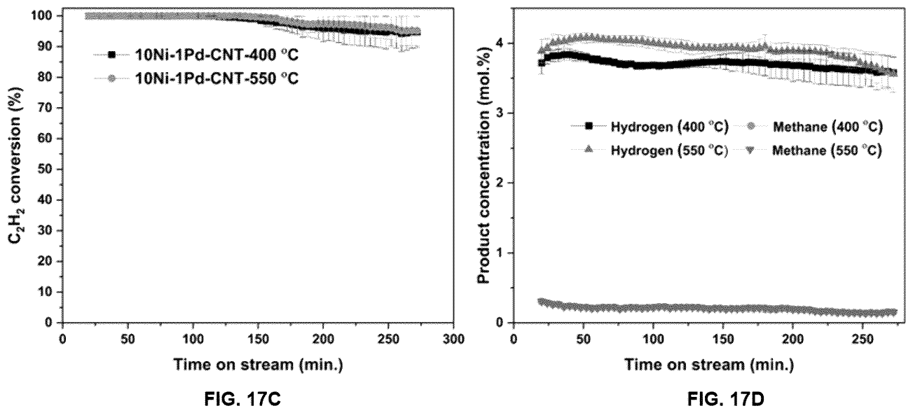

Catalytic performance of 10Ni-1Pd-CNT catalyst was characterized at two different reduction temperatures (400° C. and 550° C.) under microwave heating (at 350° C. reaction temperature). From FIG. 17A, it can be seen that acetylene conversion was constant at 100% over 270-minute reaction carried out on catalyst reduced at 400° C., whereas for reaction carried out at a catalyst reduction temperature of 550° C. under microwave heating conversion, the acetylene conversion was constant at 100% for up to 130 min and then decreased to 86% at 270 min. FIG. 17B shows a representative product concentration profile for a disclosed 10Ni-1Pd-CNT catalyst. The data show that at initial TOS, the dominant gas product was hydrogen with 4 mol % at the wo different reduction temperatures (400° C. and 550° C.). For reaction carried out using a catalyst reduction temperature of 400° C. H₂, production rate decreased to 3.8 mol % at 270 min, whereas when a 550° C. catalyst reduction temperature was used, the H₂ production rate was high at 4.2 mol % at 60 min and then decreased to 3.2 mol % at 270 min TOS. Without wishing to be bound by a particular theory, it is believed that a lower observed production rate can be attributed to low C₂H₂ conversion when a catalyst reduction temperature of 550° C. is used. Additional experimental data are shown in FIGS. 17C-17D.

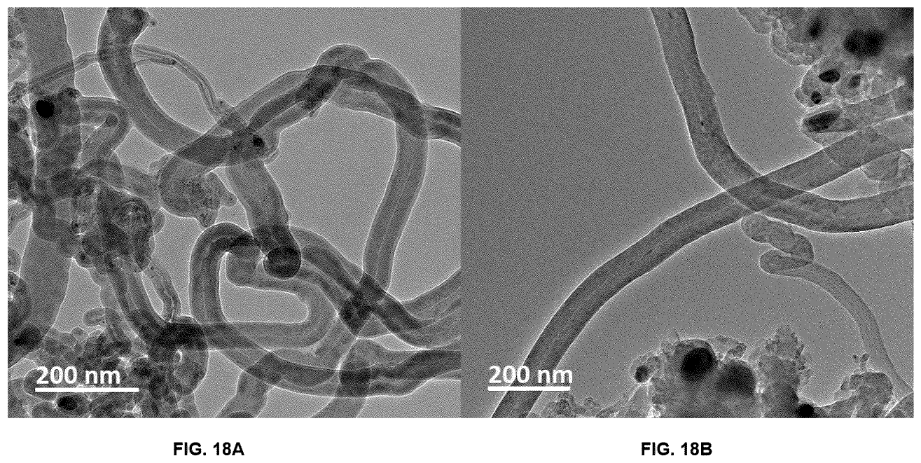

Carbon deposited over the catalyst appeared to be carbon nanofibers having a cylindrical shape. FIGS. 18A-18B show CNT growth over a disclosed 10Ni-CNT catalyst with Ni metal entrapped inside the CNT. The average diameter CNT produced in the reaction was 45 nm and 65 nm over a disclosed 10Ni-1Pd-CNT catalyst was reduced at 400° C. and 550° C., respectively. The apparent CNT growth appears to be tip-growth.

In separate experiments, carbon nanotube growth was determined over a 10Ni-CNT catalyst with Ni metal entrapped inside the CNT. The average diameter CNT generated was 53.9 nm and 68.4 nm over 10Ni-1Pd-CNT catalyst reduced at 400° C. and 550° C., respectively.

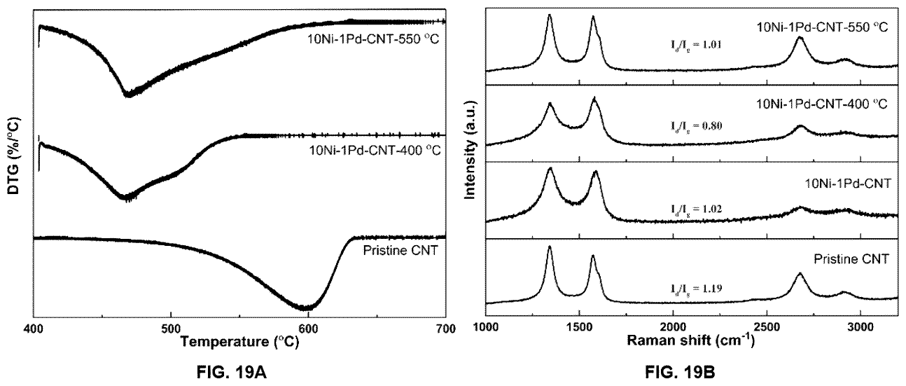

CNT produced during the reaction was examined using TGA analysis. FIG. 19A shows the oxidation temperature peak for the spent disclosed 10Ni-1Pd-CNT catalyst. The data show that the oxidation temperature of CNT support in the spent catalyst was higher than 450° C., suggesting carbon materials produced on the spent catalyst are crystalline in nature. Raman spectroscopy was performed over the catalyst to further assess crystallinity of spent catalyst and the data are shown in FIG. 19B. When the catalyst was reduced at 400° C., the I_{d}/I_{g} ratio changed from 1.02 to 0.8 between reduced to spent samples, while for catalyst reduced at 550° C. there was no change is observed in the I_{d}/I_{g} ratio. These data suggest that the catalyst reduced at 400° C. can provide more ordered graphitic carbon that is deposited during C₂H₂ pyrolysis.

### 12. CONCLUSION

The examples show the utility and success of the disclosed methods and processes for catalytic conversion of acetylene, e.g., as produced during plasma pyrolysis of methane, to COₓ-free H₂ and valuable solid carbon such as CNT. In some examples, the disclosed methods and processes for catalytic conversion of acetylene utilized Ni monometallic and Ni—Pd bimetallic catalyst supported on CNT and Al₂O₃, and the disclosed methods and processes for catalytic conversion of acetylene using microwave irradiation are compared herein to thermal heating showing that microwave irradiation achieves the desired conversion of acetylene efficiently and at reduced temperature. The foregoing examples show that the carbon materials formed in the disclosed methods and processes for catalytic conversion of acetylene are value-add carbon nanomaterials such as CNTs. The foregoing examples demonstrate in the disclosed methods and processes for catalytic conversion of acetylene, that acetylene can be converted to carbon nanotubes at low reaction temperature (−350° C.) without affecting useful physiochemical properties of the carbon nanomaterials. In addition, the foregoing examples show that introduction of Pd into the catalyst system significantly improved the catalytic activity in the disclosed methods and processes for catalytic conversion of acetylene, e.g., introduction of Pd increased the stability of the catalyst for a long-duration operation. Finally, the foregoing examples provide characterization data of the solid carbon deposited over the Pd incorporated Ni catalyst under different reaction parameters such as reduction temperature, reaction temperature and heating source is more crystalline (low I_{d}/I_{g} ratio) as compared to monometallic Ni catalyst.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for producing hydrogen and carbon nanomaterials from acetylene, the method comprising:
(a) applying microwave radiation to the acetylene in the presence of a catalyst comprising metal atoms, wherein the microwave radiation causes the acetylene to decompose into hydrogen and at least one solid carbon product;
(b) separating the hydrogen and the at least one solid carbon product.

2. The method of claim 1, further comprising:
(c) contacting the catalyst and the at least one solid carbon product with an acid composition, wherein the acid composition causes the metal atoms to separate from the at least one solid carbon product;
(d) removing the metal atoms from the acid composition; and
(e) removing the at least one solid carbon product from the acid composition.

3. The method of claim 2, further comprising step (f): using a portion of the at least one solid carbon product as a supporting solid carbon product to restart the method beginning at step (a).

4. The method of claim 1, wherein the catalyst further comprises a support.

5. The method of claim 4, wherein the support comprises a supporting solid carbon product, Al₂O₃, or a combination thereof.

6. The method of claim 5, wherein the Al₂O₃ comprises a Al₂O₃ aerogel.

7. The method of claim 1, wherein the catalyst is unsupported.

8. The method of claim 1, wherein the catalyst comprises Ni, Ni—Pd, or a combination thereof.

9. The method of claim 8, wherein the catalyst is monometallic.

10. The method of claim 8, wherein the catalyst is bimetallic.

11. The method of claim 1, wherein the catalyst further comprises a dopant.

12. The method of claim 11, wherein the dopant comprises an alkali metal, an alkaline earth metal, a transition metal, or a combination thereof.

13. The method of claim 12, wherein the alkali metal comprises Li, Na, K, Cs or a combination thereof.

14. The method of claim 1, wherein the catalyst comprises Ni, Ni—Pd, or a combination thereof; and wherein the support comprises a supporting solid carbon product.

15. The method of claim 1, wherein the catalyst comprises Ni, Ni—Pd, or a combination thereof; and the support comprises Al₂O₃.

16. The method of claim 15, wherein the catalyst comprises Ni—Pd and wherein the ratio of Ni:Pd:support is from about 8:1:91 to about 12:1:87.

17. The method of claim 1, wherein the solid carbon product and the supporting solid carbon product independently comprise nanoparticles, fullerenes, carbon filaments, single-walled carbon nanotubes, multi-walled carbon nanotubes, carbon nanofibers, or a combination thereof.

18. The method of claim 17, wherein the single-walled carbon nanotubes, multi-walled carbon nanotubes, or carbon nanofibers have a length of from about 20 nm to about 50 μm.

19. The method of claim 25, wherein from about 5 wt % to about 90 wt % of the solid carbon product is used to restart the method at step (a).

20. A composition comprising hydrogen and at least one solid carbon product, produced by the method of any of the preceding claims.
